(19) United States
(12) Patent Application Publication
(10) Pub. No.: US 2007/0083015 A1
(43) Pub. Date: Apr. 12, 2007

(54) Modified poly(ethynylene phenylene ethynylene silylene) polymers, compositions containing them, processing for preparing them and cured products

(76) Inventors: Pierrick Buvat, MONTBAZON (FR); Fabien Nony, Nonts (FR)

Correspondence Address: MCKENNA LONG & ALDRIDGE LLP, 1900 K STREET, NW, WASHINGTON, DC, 20006, US

(21) Appl. No.: 10/578,370

(22) PCT Filed: Nov. 10, 2004
(86) PCT No.: PCT/FR04/50577

§ 371 Date: May 5, 2006

(30) Foreign Application Priority Data
Nov. 13, 2003 (FR) 0350832

(51) Int. Cl. C08F 8/42

(52) U.S. Cl. 525/342

(57) ABSTRACT

Poisoned modified polymer of poly(ethynylene phenylene ethynylene silylene) type that may be obtained by selective addition of a compound containing only one reactive function to the acetylenic bonds of a poly(ethynylene phenylene ethynylene silylene) polymer. Compositions containing these modified polymers. Process for preparing these modified polymers. Novel self-poisoned polymers of poly(ethynylene phenylene ethynylene silylene) type. Cured products that may be obtained by heat treatment of the said modified or self-poisoned polymers. The polymers and cured products have improved mechanical properties while maintaining excellent thermal properties.

### TECHNICAL FIELD

The present invention relates to modified polymers of poly(ethynylene phenylene ethynylene silylene) type.

The invention also relates to compositions containing these modified polymers.

The invention also relates to the processes for preparing these modified polymers.

The invention also relates to novel self-poisoned polymers of poly(ethynylene phenylene ethynylene silylene) type.

Finally, the invention relates to the cured products that may be obtained by heat treatment of the said modified or self-poisoned polymers.

The technical field of the present invention may be defined as that of heat-stable plastics, i.e. polymers that can withstand high temperatures that may, for example, be up to 600° C.

The industrial needs for such heat-stable plastics have increased enormously in recent decades, in particular in the electronics and aerospace fields.

Such polymers have been developed to overcome the drawbacks of the materials previously used in similar applications.

Specifically, it is known that metals such as iron, titanium and steel have very high heat resistance, but they are heavy. Aluminium is light, but has low heat resistance, i.e. up to about 300° C. Ceramics such as SiC, Si₃N₄ and silica are lighter than metals and very heat-resistant, but they are not mouldable. It is for this reason that many plastics have been synthesized, which are light, mouldable and have good mechanical properties; these plastics are essentially carbon-based polymers.

Polyimides have the highest heat resistance of all plastics, with a thermal deformation temperature of 460° C.; however, these compounds, which are listed as being the most stable currently known, are very difficult to use. Other polymers such as polybenzimidazoles, polybenzothiazoles and polybenzoxazoles have even higher heat resistance than that of polyimides, but they are not mouldable and are flammable.

Silicon-based polymers such as silicones or carbosilanes have also been intensively studied. These polymers, such as poly(silylene ethynylene) compounds, are generally used as precursors of ceramics of silicon carbide SiC type, reserve compounds and conductive materials.

It has recently been shown in document [4] that poly[(phenyl silylene) ethynylene-1,3-phenylene ethynylene] (or MSP), prepared by a synthetic process involving polymerization reactions by dehydrocoupling between phenylsilane and m-diethynylbenzene, have remarkably high heat stability. This is confirmed in document [1], which more generally demonstrates the excellent heat-stability properties, for organic compounds, of poly(silylene ethynylene phenylene ethynylenes) which comprise a repeating unit represented by formula (A) below:

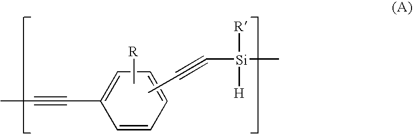

The synthesis of polycarbosilanes comprising a silane function and a diethynylbenzene via standard processes using metal catalysts leads to polymers of low purity containing large traces of metal catalysts, which greatly impair their thermal properties.

Other improved synthetic processes are presented in document [2]: these are palladium-catalysed syntheses, but in fact they apply only to a very limited number of specific polymers in which the silicon bears two phenyl or methyl groups, for example.

In particular, it will be noted that the compounds whose repeating unit has been described above by formula (A) cannot be synthesized by this process. It is found that the SiH bonds of such compounds are very advantageous since they are extremely reactive and can give rise to numerous rearrangements and reactions.

Compounds comprising a repeating unit of formula (A) are particularly difficult to obtain.

Another process of cross-dehydrocoupling or polycondensation of silanes with alkynes in the presence of a catalytic system based on copper chloride and an amine is described in document [3]. However, this process is also limited to a few polymers and results in compounds whose structure is partially crosslinked and whose mass-average molecular weight is very high (10⁴ to 10⁵). These structural defects seriously impair both the solubility properties and the thermal properties of these polymers.

Another synthetic process that is directed towards overcoming the drawbacks of the processes described above, and towards preparing pure compounds, without traces of metals, and with excellent and well-defined properties, especially in terms of heat stability, was proposed in the abovementioned document [4]. This process essentially allows the synthesis of the compounds of formula (A) above in which the silicon bears a hydrogen atom. The process according to [4] is a polycondensation by dehydrogenation of a functionalized hydrosilane with a compound of diethynyl type in the presence of a metal oxide such as MgO, according to the reaction scheme (B) below:

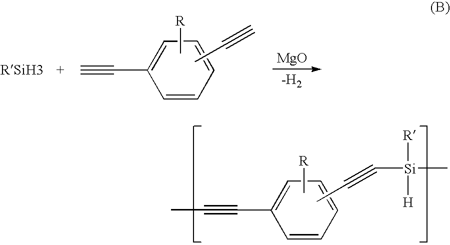

This process leads to weakly crosslinked polymers having, as represented above, excellent heat stability, but whose mass distribution is, however, very broad.

In another, more recent publication [1], the same authors prepared a series of polymers comprising the —Si(H)—C≡C— unit via process (B) and via another more advantageous process, involving the condensation reaction of dichlorosilane and of diethynylic organomagnesium reagents followed by reaction of the product obtained with a monochlorosilane, followed by a hydrolysis, according to the reaction scheme (C) below:

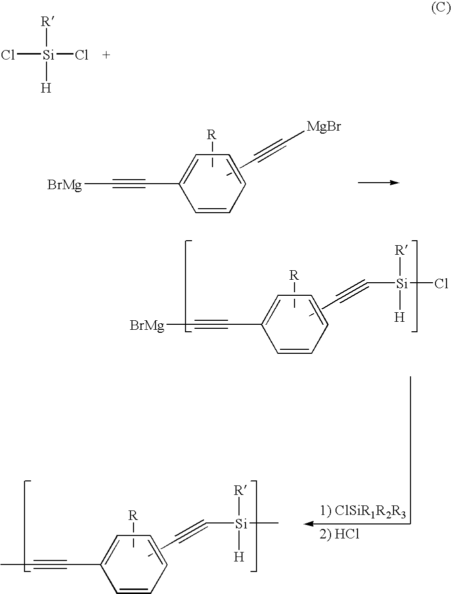

In contrast with process (B), process (C) allows the production of polymers without structural defects, with good yields and a low mass distribution.

The compounds obtained by this process are totally pure and have fully characterized thermal properties. They are thermosetting polymers.

The said document also discloses the preparation of the polymers mentioned above reinforced with glass, carbon or SiC fibres.

A patent relating to polymers comprising the very general repeating unit (D): 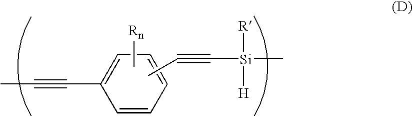
in which R and R′ relate to numerous groups known in organic chemistry, was granted to the authors of documents [1] and [4]; this is document EP-B1-0 617 073 (corresponding to American patent U.S. Pat. No. 5,420, 238).

These polymers are prepared essentially by the process of scheme (C) and possibly by the process of scheme (B), and they have a weight-average molecular mass of 500 to 1 000 000. The said document also describes cured products based on these polymers and their preparation by a heat treatment. It is indicated that the polymers in the said document can be used as heat-stable polymers, fire-resistant polymers, conductive polymers, and materials for electroluminescent elements. In fact, it appears that such polymers are essentially used as organic precursors of ceramics.

The excellent heat stability of the polymers prepared especially in document EP-B1-0 617 073 makes them capable of constituting the resin forming the organic matrix of heat-stable composite materials.

Many techniques for producing composites exist.

In very general terms, the various processes involve injection techniques (especially RTM) or prepreg compacting techniques.

Prepregs are semi-finished products, of low thickness, consisting of fibres impregnated with resin. Prepregs that are intended for producing high-performance composite structures contain at least 50% fibre by volume.

Also, during use, the matrix will have to have a low viscosity in order to penetrate the reinforcing sheet and correctly impregnate the fibre so as to prevent it from distorting and conserve its integrity. Reinforcing fibres are impregnated either with a solution of resin in a suitable solvent, or with the pure resin melt; this is the “hot-melt” technique. The technology for manufacturing prepregs with a thermoplastic matrix is substantially governed by the morphology and the rheological properties of the polymers.

Injection moulding is a process that consists in injecting the liquid resin into the textile-reinforcing agent positioned beforehand in the imprint consisting of the mould and the counter-mould. The most important parameter is the viscosity, which must be between 100 and 1000 mPa·s at the injection temperature, which is generally from 50 to 250° C.

For these two techniques, the viscosity is thus the critical parameter, which conditions the ability of the polymer to be used.

Amorphous polymers correspond to macromolecules with a totally disordered skeleton structure. They are characterized by their glass transition temperature (Tg) corresponding to the change from the vitreous state to the rubbery state. Above the Tg, the thermoplastics are characterized, however, by great creep strength.

The polymers prepared in document EP-B1-0 617 073 are compounds that are in powder form. The inventors have shown, by reproducing the syntheses described in the said document, that the polymers prepared would have glass transition temperatures in the region of 50° C.

Below this temperature, the viscosity of the polymer is infinite, and above this temperature, the viscosity decreases gradually as the temperature is increased.

However, this drop in viscosity is not sufficient for the polymer to be able to be used in processes conventionally used in the field of composites such as RTM and preimpregnation, already described above.

Document FR-A-2 798 662 from Buvat et al. describes polymers whose structure is similar to those described in patent EP-B1-0 617 073, i.e. polymers having all their advantageous properties, especially the heat stability, but the viscosity of which is low enough for them to be usable, manipulable or “processable” at temperatures of, for example, 100 to 120° C., which are the temperatures commonly used in injection-moulding or impregnation techniques.

These polymers described in document FR-A-2 798 622 correspond to formula (I) below: 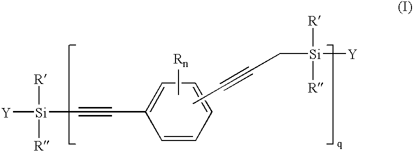
or to formula (Ia) below:

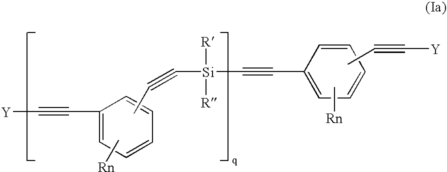

These polymers may be defined as being polymers of low mass containing as base unit moiety a functionalized silane coupled to a diethynyl benzene and bearing in particular phenylacetylenic functions at the end of the chain.

Reference may be made to document FR-A-2 798 662 for the meaning of the various symbols used in these formulae. It is important to note that the polymers according to FR-A-2 798 662 have a structure substantially analogous to that of the polymers of document EP-B1-0 617 073, with the fundamental exception, however, of the presence at the end of the chain of groups Y derived from a chain-limiting agent. The heat-stable polymers of FR-A-2 798 622 have fully defined and modifiable rheological properties, which allows them to be used as matrices for heat-stable composites. All the properties of these polymers are described in FR-A-2 798 622, to which reference may be made.

Document FR-A-2 798 622 also describes a process for synthesizing these heat-stable polymers. The technique developed makes it possible to control as desired the viscosity of the polymer, as a function of the technological working constraints of the composite. This property is closely associated with the molecular mass of the polymer. The low viscosities are observed on polymers of low molecular masses. Control of the masses is obtained by adding to the reaction medium a reactive species that blocks the polymerization reaction without affecting the overall reaction yield. This species is an analogue of one of the two reagents used for the synthesis of the polymer, but bearing only one function allowing coupling. When this species is introduced into the polymer chain, growth is stopped. The length of the polymer is thus readily controlled by means of measured additions of chain limiter. A detailed description of the processes for synthesizing the polymers described above is given in document FR-A-2 798 622, to which reference may be made.

Moreover, since the prepolymers prepared both in document EP-B1-0 617 073 from Itoh and in document FR-A-2 798 622 from Buvat are thermosetting, the crosslinking of these materials is heat-activated.

The reactions involved in this phenomenon mainly involve two mechanisms, which are described in an article published by Itoh [5].

The first mechanism is a Diels-Alder reaction, involving an acetylenic bond coupled to an aromatic nucleus, on the one hand, and another aromatic bond, on the other hand. This reaction may be illustrated in the following manner:

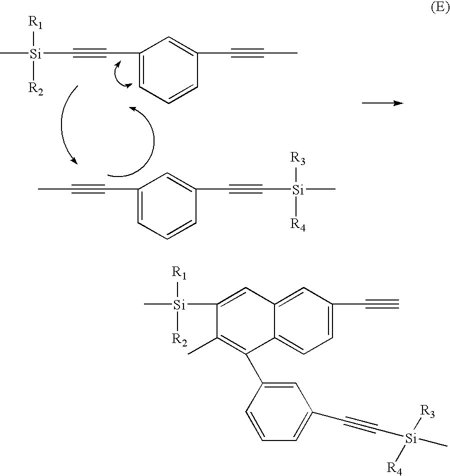

This reaction generates a naphthalene unit. It can take place irrespective of the nature of R₁, R₂, R₃ or R₄.

The structures obtained by this mechanism are thus highly aromatic and comprise many unsaturated bonds. These characteristics are the source of the excellent thermal properties observed for these polymers.

The second mechanism, which takes place during the crosslinking reaction of the poly(ethynylene phenylene ethynylene silylene) prepolymers, is a hydrosilylation reaction, involving the SiH bond and an acetylenic triple bond. This reaction may be illustrated in the following manner:

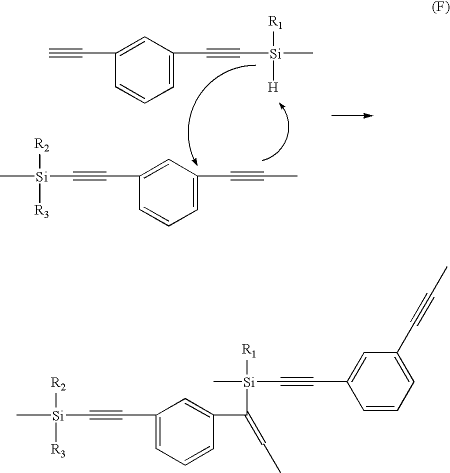

This reaction takes place only for compounds whose silicon bears the SiH bond.

For the latter compounds, the hydrosilylation reaction is activated at lower temperature (for example 150 to 250° C.) than those for the Diels-Alder reactions.

A polymer or macromolecular network is, inter alia, defined by the crosslinking density and by the length of the chain units that separate two crosslinking points or nodes. These characteristics predominantly govern the mechanical properties of the polymers. Thus, highly crosslinked networks with short chain units are classified in the range of materials with low deformability. Phenolic resins or phenolic cyanate ester resins especially form part of this category of materials.

In the case of poly(ethynylene phenylene ethynylene silylenes), the crosslinking involves the acetylenic triple bonds, simply separated by an aromatic nucleus. Consequently, the crosslinking density is very high and the inter-node chain units are very short. Cured materials based on poly(ethynylene phenylene ethynylene silylene) are consequently among the polymer matrices with low deformability.

The crosslinking density may be controlled during the use of the polymer via suitable heat treatments. Specifically, the crosslinking of the polymer stops when the mobility of the macromolecular chains is no longer sufficient. It is accepted that this mobility is sufficient once the working temperature is above the glass transition temperature of the network. Consequently, the glass transition temperature cannot exceed the working temperature, and the crosslinking density is thus controlled by the curing temperature of the polymer.

However, under crosslinked materials are unstable materials whose use, at temperatures above the working temperature, will give rise to a change in the structure.

The mechanical properties of poly(ethynylene phenylene ethynylene silylenes) are, consequently, difficult to regulate via heat treatment.

However, the nature of the chemical groups borne by the silicon is capable of regulating these properties. Specifically, long chains may act as plasticizers and reduce the rigidity of the associated materials. However, this principle encounters limits in terms of heat stability of the polymer, since this stability is then affected.

Document FR-A-2 816 624 describes poly(ethynylene phenylene ethynylene silylene) polymers comprising as repeating unit, inter alia, two acetylenic units, at least one silicon atom and an inert spacer that does not take part in the crosslinking processes. The role of the spacer is to increase the length of the inter-node crosslinking chains to contribute towards greater mobility within the network and thus greater flexibility of the resulting cured materials. The nature of the spacer also makes it possible to modify the mechanical properties without significantly modifying the thermal properties. The polymers as defined in this document may optionally comprise acetylenic functions at the end of the chain, in accordance with document FR-A-2 798 662. Reference may be made to the description of document FR-A-2 816 624 as regards the various formulae that can represent the repeating units and the polymers of this document.

However, although the strain capacity of networks comprising the polymers of document FR-A-2 816 624 is found to be markedly increased, the heat stability of these polymers is very often reduced. Moreover, the mechanical properties of the corresponding cured materials are degraded during heat treatments at temperatures of greater than or equal to 300° C.

Document FR-A-2 836 922 describes a composition comprising a blend of at least one poly(ethynylene phenylene ethynylene silylene) polymer and of at least one compound capable of exerting a plasticizing effect in the blend, once this blend has been cured.

The preparation of a specific blend comprising, besides a poly(ethynylene phenylene ethynylene silylene) polymer, a compound capable of exerting a plasticizing effect in the blend once cured leads to compounds or cured products whose mechanical properties are greatly improved, compared with the cured products prepared prior to the said document, as described, for example, in documents EP-B1-0 617 073 and FR-A-2 798 622, without their thermal properties, which remain excellent, being affected.

In particular, the cured products prepared by heat treatment of the compositions according to document FR-A-2 836 922 are more supple, more flexible and less brittle than the cured products prepared by heat treatment of compositions containing a poly(ethynylene phenylene ethynylene silylene), and which do not include a compound capable of exerting a plasticizing effect.

The fundamental compound included in the blend of the composition of this document is defined as a compound capable of exerting a plasticizing effect in the blend, once this blend is cured.

In general, the expression “compound capable of exerting a plasticizing effect in the blend, once this blend is cured” means any compound that causes an increase (even a minute increase) in the “plastic” nature of the cured product—i.e. an increase in the deformability of the material consisting of the cured product under stress—compared with a cured product not containing said compound.

This especially means that in the cured products prepared from the compositions of this document, the compound exerts an effect of decreasing the rigidity and the hardness, and, conversely, of increasing the suppleness and flexibility of the cured product when compared with a cured product containing the same polymer, but not containing the said compound capable of exerting a plasticizing effect.

It is important to note that, according to this document, the compound “capable of exerting a plasticizing effect” is not necessarily a “plasticizer”, as it is commonly defined, especially in the field of plastics and plastics processing.

Specifically, this compound may be chosen from numerous compounds that are not, in general, commonly defined as being plasticizers, but which, in the context of the compositions of this document, are adequate compounds, in the sense that they exert a plasticizing effect in the cured product.

However, plasticizers that are known per se may also be used as the said compound.

In other words, as has been seen above, since the cured products prepared from poly(ethynylene phenylene ethynylene silylene) are extremely hard, rigid and brittle, the inclusion in such a product of a compound that is relatively more supple than the polymer, although not traditionally listed as being a “plasticizer”, suffices to give rise to an increase in the mobility of the polymer network and thus to exert a plasticizing effect.

The compound included in the blend, although not intrinsically being a “plasticizer”, does then indeed act in the final cured material as a “plasticizer”.

The compound capable of exerting a plasticizing effect in this document is generally chosen from organic and inorganic resins and polymers.

The organic polymers are generally chosen from thermo-plastic polymers and thermosetting polymers.

The thermoplastic polymers may be chosen, for example, from fluoro polymers.

The thermosetting polymers may be chosen, for example, from epoxy resins, polyimides (poly(bismaleimides)), polyisocyanates, phenyl-formaldehyde resins, silicones or polysiloxanes and any other aromatic and/or heterocyclic polymers.

Preferably, the compound capable of exerting a plasticizing effect, such as a polymer, is a reactive compound, i.e. it is capable of reacting with itself or with another compound capable of exerting a plasticizing effect or with poly(ethynylene phenylene ethynylene silylene). Such reactive compounds, such as polymers, generally comprise at least one reactive function, chosen from acetylenic functions and hydrogenated silane functions.

Preferably, the reactive compound is chosen from hydrogenated silicone resins and polymers and/or silicone resins and polymers comprising at least one acetylenic function. Silicones are known for their high heat resistance and their high strain capacity under mechanical stress. Reference will be made to the description of document FR-A-2 836 922 for a detailed definition of these silicone resins and polymers.

The composition of this document, i.e. the composition comprising a blend of at least one poly(ethynylene phenylene ethynylene silylene) polymer and of at least one compound capable of exerting a plasticizing effect in the blend once this blend has been cured, in other words, the “plasticized” poly(ethynylene phenylene ethynylene silylene) resin, may also be cured at temperatures below the (thermal) crosslinking temperatures, under the action of a catalyst for Diels-Alder reactions and hydrosilylation reactions. In particular, platinum-based catalysts such as H₂PtCl₆, Pt(DVDS), Pt(TVTS) and Pt(dba), in which DVDS represents divinyldisiloxane, TVTS represents trivinyltrisiloxane and dba represents dibenzylideneacetone; and transition metal complexes such as Rh₆(CO)₁₆ or Rh₄(CO)₁₂, ClRh(PPh₃), Ir₄(CO)₁₂ and Pd(dba) may be used to catalyse the hydrosilylation reactions.

Catalysts based on a pentachloride of a transition metal, such as TaCl₅, NbCl₅ or MoCl₅, will themselves be advantageously used to catalyse the reactions of Diels-Alder type.

The catalysis of these reactions makes it possible to use “plasticizing” compounds of low molecular mass and thus of low boiling point. These compounds are readily selected by a person skilled in the art from the compounds capable of exerting a plasticizing effect mentioned above. These “plasticizers” are advantageously used to lower the viscosity of the blend before processing.

The materials obtained by curing the compositions of the said document FR-A-2 836 922 have improved mechanical properties compared with the products obtained by curing unmodified poly(ethynylene phenylene ethynylene silylene)s. The strain capacities of the networks thus cured are in particular appreciably improved.

However, the mechanical properties of the cured materials obtained in the said document are still insufficient especially as regards their deformability, and they also suffer weakening and degradation when these materials are subjected to high temperatures.

There is thus a need for a poly(ethynylene phenylene ethynylene silylene) polymer which, while having all the advantageous properties of these polymers, especially in terms of heat stability, also has improved and modifiable mechanical properties.

There is also a need for polymers of poly(ethynylene phenylene ethynylene silylene) type which give, by heat treatment, cured products whose mechanical properties are improved, in particular as regards the breaking strain, but also the modulus of elasticity and the breaking (rupture) stress.

These improved mechanical properties must be obtained without the other advantageous properties of these cured products, in particular as regards heat stability and processability, being affected.

In addition, these mechanical properties should not suffer any weakening or degradation, and should be maintained when the cured material or polymer is subjected to high temperatures, for example above 300° C.

In addition, preferably, the polymer and the composition containing it should have a viscosity that is low enough for them to be processable and manipulable at these temperatures, for example of from 100 to 120° C., which are the temperatures commonly used in injection-moulding and impregnation techniques.

The aim of the invention is to provide modified polymers of poly(ethynylene phenylene ethynylene silylene) type, compositions of these polymers and cured products prepared from these polymers, which satisfy, inter alia, the needs listed above, which satisfy the requirements indicated above, and which do not have the drawbacks, defects, limitations and disadvantages of the cured products, compositions and polymers of the prior art as represented in particular by documents EP-B1-0 617 073; FR-A-2 798 622; FR-A-2 816 624; FR-A-2 816 623 and FR-A-2 836 922.

The aim of the invention is also to provide cured products, compositions and polymers that solve the problems of the prior art.

This aim, and others, is achieved, in accordance with the invention, by a modified poly(ethynylene phenylene ethynylene silylene) polymer that may be obtained (obtainable) by selective addition of a compound containing only one reactive function to the acetylenic bonds of a poly(ethynylene phenylene ethynylene silylene) polymer.

The polymer according to the invention may be defined as a modified or “poisoned” poly(ethynylene phenylene ethynylene silylene) (“PEPES”) polymer.

The polymers according to the invention satisfy all of the needs listed above, satisfy the requirements and criteria defined above and solve the problems posed by the unmodified PEPES polymers of the prior art.

In particular, the modified polymers according to the invention, and also the cured products obtained from these modified polymers, have improved and enhanced mechanical properties when compared with the unmodified polymers of the prior art, as represented, for example, by documents EP-B1-0 617 073, FR-A-2 798 622, FR-A-2 816 624, FR-A-2 816 623 and FR-A-2 836 922, whereas their thermal properties are maintained.

The improvement in the mechanical properties especially concerns the deformability of the cured or crosslinked materials, which is considerably enhanced.

Modified poly(ethynylene phenylene ethynylene silylene) polymers according to the invention, which may be obtained by selective addition of a specific compound containing only one reactive function to the acetylenic bonds of a poly(ethynylene phenylene ethynylene silylene) polymer are not described in the prior art.

This addition takes place on an already-prepared PEPES polymer rather than during the process of production of the said polymer, i.e. during the polymerization reactions leading to the polymer. The compound containing only one reactive function reacts a posteriori with the (unmodified) PEPES polymer and does not in any way participate in the polymerization process leading thereto.

The inventors have demonstrated that although the plasticization of (unmodified) PEPES polymers, especially with Si—H functionalized oligomers, as described in document FR-A-2 836 922, makes it possible to consume some of the acetylenic bonds, it does not, however, prevent the Diels-Alder reactions. These reactions take place at high temperatures, for example of greater than or equal to 300° C., and contribute towards weakening the properties of the cured networks obtained from the polymers.

The polymer according to the invention is prepared by addition of a monofunctional reactive species.

It turns out, surprisingly, that this reactive species poisons, makes it possible to selectively block all or some of the active sites constituted by the acetylenic bonds, these acetylenic active sites being the active sites that are necessary for one of the crosslinking mechanisms of the polymers, namely the Diels-Alder mechanism.

More specifically, the polymer according to the invention is prepared using monofunctional compounds, for which it was found, surprisingly, that they specifically poison the acetylenic bonds exclusively, by selective addition.

This poisoning may be total or partial depending on the amount of monofunctional compound used.

Furthermore, the addition of the compound containing only one reactive function to a PEPES polymer leads, surprisingly, via the consumption of the acetylenic bonds, to inhibition of the Diels-Alder mechanisms that take place during crosslinking; this type of reaction was not prevented, for example, by plasticization of the PEPES polymer. It is found that the inhibition of these reactions leads to control of the crosslinking density.

According to the invention, the concentration of reactive sites and thus the final crosslinking density of the cured networks is thus reduced, which increases, surprisingly, all of the mechanical properties and especially the deformability and breaking stress of the crosslinked materials.

Furthermore, since the crosslinking density is reduced, the macromolecular mobility of the modified networks of the cured material is increased and the systems reach their maximum conversion more quickly, which limits the subsequent change and degradation of the properties, especially the mechanical properties, of these networks, at high temperatures, for example at temperatures above 300° C. This degradation was one of the fundamental drawbacks of the polymers, optionally with addition of plasticizer, of the prior art.

It may be stated that the invention is based on the control of the crosslinking density of the networks, and also on the promotion/inhibition of certain reactions leading to a favourable architecture of the network combined with improved mechanical properties.

The compound containing only one reactive function is advantageously chosen from compounds whose sole reactive function is a hydrogen, this compound preferably being chosen from monohydrogenated siliceous compounds.

These monohydrogenated siliceous compounds may be chosen from the monohydrogenated silanes corresponding to the following formula: 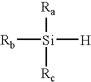
in which Rₐ, R_{b} and R_{c}, which may be identical or different, each independently represent an alkyl radical of 1 to 20 C such as a methyl radical, an alkenyl radical of 2 to 20 C or an aryl radical of 6 to 20 C such as a phenyl radical.

The modified polymers according to the invention in which the compound containing only one reactive function is chosen from monohydrogenated silanes corresponding to the formula given above, in particular, have surprising effects. These surprising effects are especially detailed in Examples 1 and 3 given later.

Specifically, more particularly for these polymers, the treatments applied associated essentially with their modification by the compound containing only one reactive function make it possible to increase both the Young's modulus and the breaking (rupture) strain of the cured material, which leads to substantially increased breaking (rupture) stresses.

Such a simultaneous increase, in both the Young's modulus and the breaking strain, is never obtained in the prior art, where any increase in one of these parameters is accompanied by a reduction in the other of these parameters.

Thus, in the prior art, an increase, for example, in the elongations at break is always accompanied by a loss as regards the Young's modulus.

For the first time, according to the invention, and in particular as regards cured products derived from polymers modified with the monohydrogenated siliceous compounds corresponding to the above formula, the two parameters are simultaneously improved and increased.

Thus, for example, the behaviour of the polymers and cured products according to the invention is very different from that observed in document FR-A-2 836 922 in which the modulus is substantially reduced when the elongation at break increases under the effect of plasticization, which leads to a small increase in the breaking stress.

The siliceous/monohydrogenated compounds may also be chosen from the monohydrogenated siloxanes corresponding to the following formula: 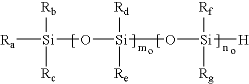
in which Rₐ, R_{b}, R_{c}, R_{d}, Rₑ, R_{f} and R_{g}, which may be identical or different, each independently represent an alkyl radical of 1 to 20 C such as a methyl radical, an alkenyl radical of 2 to 20 C, or an aryl radical of 6 to 20 C such as a phenyl radical, and nₒ and mₒ represent an integer from 0 to 1000.

The monohydrogenated siliceous compounds may also be chosen from the monohydrogenated silsesquioxanes corresponding to the following formula: 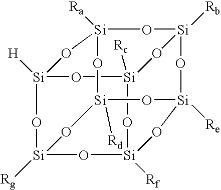
in which Rₐ, R_{b}, R_{c}, R_{d}, Rₑ, R_{f} and R_{g}, which may be identical or different, each independently represent an alkyl radical of 1 to 20 C such as a methyl radical, an alkenyl radical of 2 to 20 C, or an aryl radical of 6 to 20 C such as a phenyl radical.

Advantageously, the addition is performed in the presence of a catalyst.

This catalyst is generally a hydrosilylation reaction catalyst preferably chosen from platinum-based catalysts, such as H₂PtCl₆, Pt(DVDS), Pt(TVTS) or Pt(dba), in which DVDS represents divinyldisiloxane, TVTS represents trivinyltrisiloxane and dba represents dibenzylideneacetone; and transition metal complexes, such as Rh₆(CO)₁₆ or Rh₄(CO)₁₂, ClRh(PPh₃), Ir₄(CO)₁₂ and Pd(dba).

The addition is generally performed at a temperature of from −20° C. to 200° C. and preferably from 30 to 150° C., as a function of the viscosity and the reactivity of the polymers to be modified.

The structure and amount of the compound containing only one function (compound, poisoning agent) used make it possible to modify the nature and properties, especially the mechanical properties, of the cured networks obtained from the modified polymers according to the invention. The examples given hereinbelow, especially Example 3, demonstrate the improvements obtained in the mechanical properties, for example in three-point bending, on materials crosslinked for 2 hours at 300° C.

The compound generally represents from 0.1% to 75%, preferably from 1% to 50% and more preferably from 10% to 40% by mass relative to the mass of the modified polymer, i.e. the degree of poisoning is generally between 0.1% and 100% and preferably between 10% and 50%, as a function of the nature of the polymers and of the poisoning agents.

Advantageously, the addition is performed under an atmosphere of an inert gas such as argon.

The poly(ethynylene phenylene ethynylene silylene) (“PEPES”) polymer that is subjected to the addition, i.e. the polymer before addition, the unmodified polymer, is not particularly limited, and may be any polymer of this known type; in particular it may be poly(ethynylene phenylene ethynylene silylene)s described in documents EP-B1-0 617 073, FR-A-2 798 662, FR-A-2 816 624, FR-A-2 816 623 and FR-A-2 836 922, the relevant parts of which pertaining to these polymers are included in the present text.

According to a first embodiment of the invention, the polymer may thus correspond to formula (I) below: 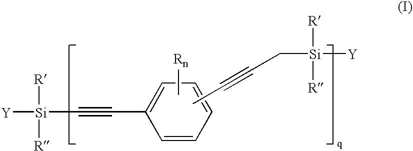
or to formula (Ia) below: 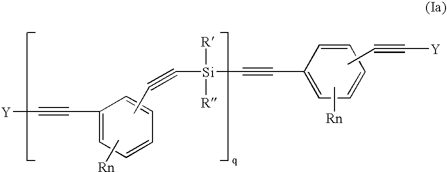
in which the phenylene group of the central repeating unit may be in the o, m or p form; R represents a halogen atom (such as F, Cl, Br and I), an alkyl group (linear or branched) containing from 1 to 20 carbon atoms, a cycloalkyl group containing from 3 to 20 carbon atoms (such as methyl, ethyl, propyl, butyl, cyclohexyl), an alkoxy group containing from 1 to 20 carbon atoms (such as methoxy, ethoxy, propoxy), an aryl group containing from 6 to 20 carbon atoms (such as a phenyl group), an aryloxy group containing from 6 to 20 carbon atoms (such as a phenoxy group), an alkenyl group (linear or branched) containing from 2 to 20 carbon atoms, a cycloalkenyl group containing from 3 to 20 carbon atoms (such as vinyl, allyl, cyclohexenyl), an alkynyl group containing from 2 to 20 carbon atoms (such as ethynyl, propargyl), an amino group, an amino group substituted with one or two substituents containing from 2 to 20 carbon atoms (such as dimethylamino, diethylamino, ethylmethylamino, methylphenylamino) or a silanyl group containing from 1 to 10 silicon atoms (such as silyl, disilanyl (—Si₂H₅), dimethylsilyl, trimethylsilyl and tetramethyldisilanyl), or one or more hydrogen atoms linked to the carbon atoms of R, may be replaced with halogen atoms (such as F, Cl, Br and I), alkyl groups, alkoxy groups (such as methoxy, ethoxy and propoxy), aryl groups, aryloxy groups (such as a phenoxy group), amino groups, amino groups substituted with one or two substituents or silanyl groups; n is an integer from 0 to 4 and q is an integer from 1 to 1000, for example from 1 to 40; R′ and R″, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, an alkynyl group containing from 2 to 20 carbon atoms, one or more of the hydrogen atoms linked to the carbon atoms of R′ and R″ possibly being replaced with halogen atoms, alkyl groups, alkoxy groups, aryl groups, aryloxy groups, amino groups, disubstituted amino groups or silanyl groups; examples of these groups have already been mentioned above for R; and Y represents a group derived from a chain-limiting agent.

The polymers according to this embodiment of the invention, which are the polymers described in document FR-A-2 798 662, have a structure substantially analogous to that of the polymers of document EP-B1-0 617 073, with the fundamental exception, however, of the presence at the end of the chain of groups Y derived from a chain-limiting agent.

This structural difference has very little influence on the advantageous properties of these polymers, in particular the heat-stability properties of the polymer, which are virtually unaffected. On the other hand, the presence at the end of the chain of this group has the effect, specifically, in that the polymer of formula (I) or (Ia) has a given and fully defined length and thus molecular weight.

Consequently, this polymer (I) or (Ia) also has fully defined and modifiable rheological properties.

The nature of the group Y depends on the nature of the chain-limiting agent from which it is derived; in the case of the polymers of formula (I), Y may represent a group of formula (III): 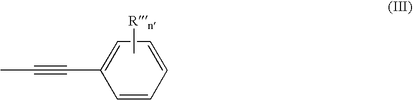
in which R″ ′ has the same meaning as R and may be identical to or different from the latter, and n′ has the same meaning as n and may be identical to or different from the latter.

Alternatively, in the case of the polymers of formula (Ia), Y may represent a group of formula (IV): 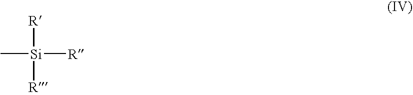
in which R′, R″ and R′″, which may be identical or different, have the meaning already given above.

One polymer that is particularly preferred of formula (I) corresponds to the following formula:

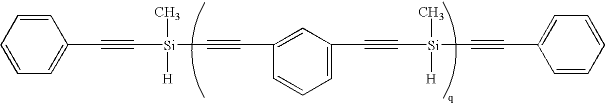

in which q is an integer from 1 to 1000, for example from 1 to 40.

Other polymers that may be used in the invention are polymers of determined molecular mass, which may be obtained by hydrolysing the polymers of formula (Ia), and which correspond to formula (Ib) below: 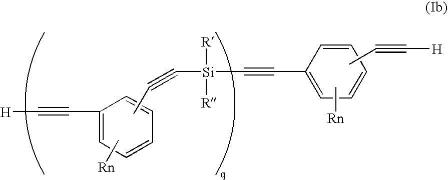
in which R, R′, R″, n and q have the meaning already given above.

The molecular mass of the polymers (I), (Ia) and (Ib) according to this embodiment of the invention is fully defined, and the length of the polymer and thus its molecular mass may be readily controlled by means of dosed additions of chain limiter into the reaction mixture, which is reflected by variable proportions of group Y in the polymer.

Thus, according to the first embodiment of the invention, the molar ratio of the groups Y at the end of the chain to the ethynylene phenylene ethynylene silylene repeating units is generally from 0.002 to 2. This ratio is preferably from 0.1 to 1.

The number-average molecular mass of polymers (I), (Ia) and (Ib) according to this first embodiment of the invention, which is fully defined, is generally from 400 to 10 000 and preferably from 400 to 5000, and the weight-average molecular mass is from 600 to 20 000 and preferably from 600 to 10 000.

According to a second embodiment of the invention, the poly(ethynylene phenylene ethynylene silylene) polymer before modification may be a polymer comprising at least one repeating unit, the said repeating unit comprising two acetylenic bonds, at least one silicon atom and at least one inert spacer group.

Advantageously, the said polymer also comprises, at the end of the chain, groups (Y) derived from a chain-limiting agent.

The term “inert spacer group” generally means a group that does not participate and does not react during crosslinking.

The repeating unit of this polymer may be repeated n₃ times, with n₃ being an integer, for example of from 2 to 1000 or alternatively from 2 to 100.

Fundamentally, the polymer, in this embodiment of the invention, comprises at least one repeating unit comprising at least one spacer group that does not participate in a crosslinking process, to which the polymer may be subsequently subjected.

The role of the spacer is especially to act as an inter-node crosslinking chain unit that is large enough to allow movements within the network.

In other words, the at least one spacer group serves spatially to space apart the triple bonds of the polymer, whether these triple bonds belong to the same repeating unit or to two different consecutive repeating units. The spacing between two triple bonds or acetylenic functions, provided by the spacer group, generally consists of linear molecules and/or of several linked aromatic nuclei, optionally separated by single bonds.

The spacer group defined above may be readily chosen by a person skilled in the art.

The choice of the nature of the spacer group also makes it possible to regulate the mechanical properties of the polymers, without significantly modifying the thermal properties.

The spacer group(s) may be chosen, for example, from groups comprising several aromatic nuclei linked via at least one covalent bond and/or at least one divalent group, polysiloxane groups, polysilane groups, etc.

When there are several spacer groups, there are preferably two of them, and they may be identical or chosen from all the possible combinations of two or more of the groups mentioned above.

Depending on the spacer group chosen, the repeating unit of the polymer according to the second embodiment of the composition of the invention may thus correspond to several formulae.

The polymer according to this second embodiment of the invention may be a polymer comprising a repeating unit of formula (V): 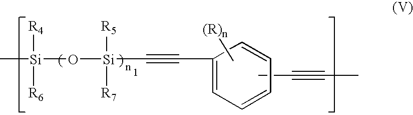
in which the phenylene group of the central repeating unit may be in the o, m or p form; R represents a halogen atom (such as F, Cl, Br and I), an alkyl group (linear or branched) containing from 1 to 20 carbon atoms, a cycloalkyl group containing from 3 to 20 carbon atoms (such as methyl, ethyl, propyl, butyl, cyclohexyl), an alkoxy group containing from 1 to 20 carbon atoms (such as methoxy, ethoxy, propoxy), an aryl group containing from 6 to 20 carbon atoms (such as a phenyl group), an aryloxy group containing from 6 to 20 carbon atoms (such as a phenoxy group), an alkenyl group (linear or branched) containing from 2 to 20 carbon atoms, a cycloalkenyl group containing from 3 to 20 carbon atoms (such as vinyl, allyl, cyclohexenyl), an alkynyl group containing from 2 to 20 carbon atoms (such as ethynyl, propargyl), an amino group, an amino group substituted with one or two substituents containing from 2 to 20 carbon atoms (such as dimethylamino, diethylamino, ethylmethylamino, methylphenylamino) or a silanyl group containing from 1 to 10 silicon atoms (such as silyl, disilanyl (—Si₂H₅), dimethylsilyl, trimethylsilyl and tetramethyldisilanyl), one or more hydrogen atoms linked to the carbon atoms of R, may be replaced with halogen atoms (such as F, Cl, Br and I), alkyl groups, alkoxy groups (such as methoxy, ethoxy and propoxy), aryl groups, aryloxy groups (such as a phenoxy group), amino groups, amino groups substituted with one or two substituents or silanyl groups; R₄, R₅, R₆ and R₇, which may be identical or different, represent a hydrogen atom; an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, an alkynyl group containing from 2 to 20 carbon atoms, one or more of the hydrogen atoms linked to the carbon atoms of R₄, R₅, R₆ and R₇ possibly being replaced with halogen atoms, alkyl groups, alkoxy groups, aryl groups, aryloxy groups, amino groups, disubstituted amino groups or silanyl groups; examples of these groups have already been mentioned above for R, n is an integer from 1 to 4, and n₃ is an integer from 1 to 10 and preferably from 1 to 4; this repeating unit is generally repeated n₃ times, with n₃ being an integer, for example from 2 to 1000 or alternatively from 2 to 100.

Alternatively, the polymer according to the second embodiment of the invention may be a polymer comprising a repeating unit of formula: 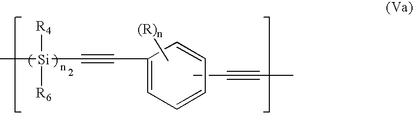
in which the phenylene group may be in the o, m or p form, and R, R₄, R₆ and n have the meaning already given above and n₂ is an integer from 2 to 10.

This repeating unit is generally repeated n₃ times, with n₃ being an integer, for example from 2 to 1000.

Alternatively, the polymer according to this second embodiment of the composition of the invention may be a polymer comprising a repeating unit of formula: 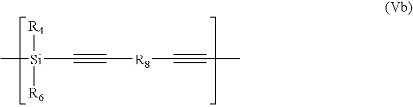
in which R₄ and R₆ have the meaning already given above, and R₈ represents a group comprising at least two aromatic nuclei comprising, for example, from 6 to 20 C, linked via at least one covalent bond and/or at least one divalent group, this repeating unit is generally repeated n₃ times, with n₃ being as defined above.

Alternatively, the polymer according to this second embodiment of the invention may be a polymer comprising a repeating unit of formula: 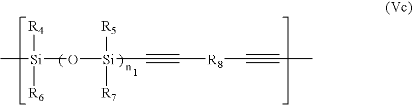
in which R₄, R₅, R₆, R₇, R₈ and n₁ have the meaning already given above, this repeating unit similarly possibly being repeated n₃ times.

Finally, the polymer according to this second embodiment of the invention may be a polymer comprising a repeating unit of formula: 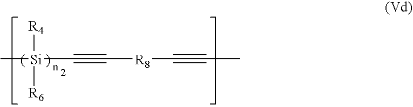
in which R₄, R₆, R₈ and n₂ have the meaning already given above, this unit possibly being repeated n₃ times.

In particular, in formulae (III), (IV) and (V) above, R₈ represents a group comprising at least two aromatic nuclei separated by at least one covalent bond and/or a divalent group.

The group R₈ may be chosen, for example, from the following groups: 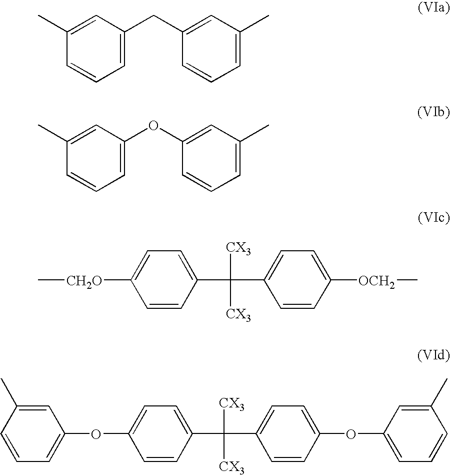
in which X represents a hydrogen atom or a halogen atom (F, Cl, Br or I).

Alternatively, the polymer according to this second embodiment of the invention may comprise several different repeating units comprising at least one inert spacer group.

The said repeating units are preferably chosen from the repeating units of formulae (V), (Va), (Vb), (Vc) and (Vd) already described above.

The said repeating units are repeated x₁, x₂, x₃, x₄ and x₅ times, respectively, in which x₁, x₂, x₃, x₄ and x₅ generally represent integers from 0 to 100 000, on condition that at least two from among x₁, x₂, x₃, x₄ and x₅ are other than 0.

This polymer containing several different repeating units may optionally also comprise one or more repeating units not comprising an inert spacer group, such as a unit of formula (Ve):

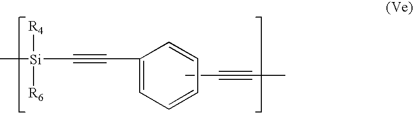

This unit is generally repeated x₆ times, with x₆ representing an integer from 0 to 100 000.

A preferred polymer corresponds, for example, to the formula: 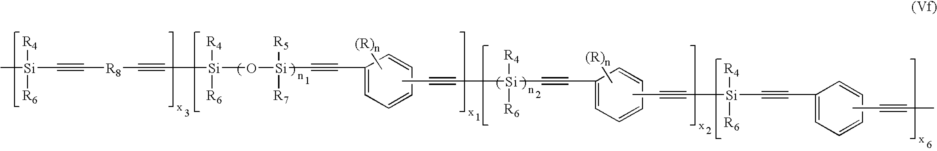
in which x₁, x₂, x₃ and x₆ are as defined above, on condition that two from among x₁, x₂ and x₃ are other than 0.

The initial unmodified polymers according to this second embodiment of the invention advantageously comprise, at the end of the chain, (end) groups (Y) derived from a chain-limiting agent, which makes it possible to control and regulate their length, their molecular mass and thus their viscosity.

The nature of the optional chain-limiting group Y depends on the nature of the chain-limiting agent from which it is derived; Y may correspond to formula (III) or (IV) given above.

The molecular mass of the polymers according to the invention is—due to the fact that they comprise a chain-limiting group—fully defined, and the length of the polymer and thus its molecular mass may be readily controlled by means of dosed additions of chain limiter into the reaction mixture, which is reflected by variable proportions of chain-limiting group Y in the polymer.

Thus, the molar ratio of the chain-limiting groups Y at the end of the chain to the repeating units of ethynylene phenylene ethynylene silylene type is generally from 0.002 to 2. This ratio is preferably from 0.1 to 1.

The number-average molecular mass of the polymers used in this second embodiment of the invention is generally from 400 to 100 000, and the weight-average molecular mass is from 500 to 1 000 000.

The number-average molecular mass of the polymers in this embodiment is advantageously, due to the fact that they preferably comprise a chain-limiting group, fully defined, and is generally from 400 to 10 000, and the weight-average molecular mass is from 600 to 20 000.

These masses are determined by gel permeation chromatography (GPC) via calibration with polystyrene.

By virtue of the fact that the unmodified polymer in this second embodiment advantageously contains chain-limiting groups, controlling the molecular mass of the polymers, which is generally in the range mentioned above, makes it possible to fully control the viscosity of the polymers.

Thus, the viscosities of the modified polymers used in this second embodiment of the invention are in a range of values from 0.1 to 1000 mPa·s for temperatures ranging from 20 to 160° C., within the mass range mentioned above.

The viscosity also depends on the nature of the groups borne by the aromatic rings and the silicon. These viscosities are entirely compatible with the standard techniques for preparing composites.

It is thus possible to modify the viscosity of the polymer as desired, as a function of the technological working constraints of the composite.

The viscosity is moreover associated with the glass transition temperature (Tg). The glass transition temperature of the polymers according to the invention will thus generally be from −150 to +100° C. and more advantageously between −100 and +20° C.

The poly(ethynylene phenylene ethynylene silylene)s used as starting materials in the invention may be prepared by any known process for preparing these polymers, for example the processes described in documents EP-B1-0 617 073 and FR-A-2 798 662.

In particular, the polymers (I) and (Ia) may be prepared by the process of document FR-A-2 798 662 and the polymers with an inert spacer group may be prepared by the processes analogous to those of documents EP-B1-0 617 073 and FR-A-2 798 662 if they comprise chain-limiting groups.

Reference may be made to these documents and to the other prior art documents mentioned above to obtain a detailed description of these processes.

The invention also relates to a process for preparing a modified PEPES polymer as described above, in which the following successive steps are performed:
a) a poly(ethynylene phenylene ethynylene silylene) (PEPES) polymer is introduced into a reactor;
b) a compound containing only one reactive function is added to the said PEPES;
c) the said PEPES and the said compound are mixed together homogeneously;
   a catalyst may optionally be added to the reactor either during step b), in the form of a mixture of the catalyst and of the compound containing only one reactive function (it is then clear that in step c), the said PEPES and the said mixture of compound and of catalyst are mixed together homogeneously); or after step c);
d) the compound, the PEPES and the optional catalyst are left in contact until the selective addition of the compound containing only one reactive function to the acetylenic bonds of the PEPES polymer is complete;
e) the modified polymer thus formed is recovered.

The term “complete” means that irrespective of the amount of compound containing only one reactive function, this compound is entirely consumed and has entirely reacted. The term “complete” does not necessarily imply a total consumption of the acetylenic bonds.

The compound containing only one reactive function has already been described hereinabove.

Advantageously, a catalyst is added to the reactor, either during step b) in the form of a mixture of the catalyst and of the compound containing only one reactive function, or to the mixture of the PEPES and of the compound after step c).

When a catalyst is used, it is preferable to introduce it into the reactor during step b) as a mixture with the compound containing only one reactive function, since proceeding in this manner ensures that the reaction is more homogeneous and more progressive, and that “hot spots” do not occur, and as a result the quality of the final material obtained is markedly better than by introducing the catalyst alone after step c), not mixed with the compound.

This catalyst is generally chosen from the compounds already listed above.

The poly(ethynylene phenylene ethynylene silylene) (PEPES) polymer of step a) (unmodified polymer, before addition) is generally chosen from the polymers already mentioned hereinabove.

Steps b) to c) and d) of the process are generally performed with stirring.

The process is generally performed at a temperature of from −20 to 200° C.

For example, during step a), the reactor, such as a round-bottomed flask, may be heated to a temperature of from 30 to 140° C. to lower the viscosity of the polymer to be modified. The mixing and homogenization step may be performed at room temperature, but if it proves to be difficult, heating at a temperature of from 30 to 140° C. may be performed to facilitate mixing. The system is then generally allowed time to return to room temperature before adding the catalyst. Step c) of bringing into contact is generally performed with heating, for example at a temperature of from 30 to 140° C. The mixture is generally allowed to return to room temperature to perform the recovery of the modified polymer formed.

The process, preferably the entire process, is generally performed under an atmosphere of an inert gas such as argon, in particular step d).

The duration of the bringing into contact of the PEPES, the monofunctional compound and the optional catalyst in step d) is generally from 0.1 to 24 hours, preferably from 0.5 to 8 hours and more preferably from 2 to 6 hours, this bringing into contact preferably being performed under an inert atmosphere, with heating and stirring.

The modified polymer is recovered by separation from the reaction medium by any suitable separation process, for example by filtration.

The invention also relates to a composition comprising a poly(ethynylene phenylene ethynylene silylene) polymer, a compound containing only one reactive function and an optional catalyst.

The compound containing only one reactive function, the polymer and the optional catalyst included in this composition are as defined above.

The composition generally comprises, by mass: from 1% to 99% of PEPES polymer, from 1% to 50% by mass of compound containing only one reactive function, and optionally from 0 to 1% by mass of catalyst.

The “poisoned” modified polymers according to the invention have a structure that it is not always possible to define unambiguously with a formula, which is why they have been defined above as “being able to be prepared” (obtainable) by selective addition of a monofunctional compound to a PEPES polymer.

However, “poisoned” modified polymers according to the invention may be represented by the following formula: 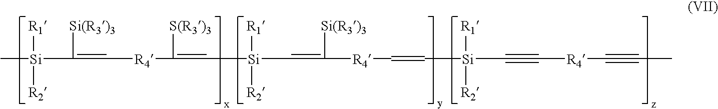
in which R₁′ and R₂′, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, an alkynyl group containing from 2 to 20 carbon atoms, one or more of the hydrogen atoms linked to the carbon atoms of R₁′ and R₂′ may be replaced with halogen atoms, alkyl groups, alkoxy groups, aryl groups, aryloxy groups, amino groups, disubstituted amino groups or silanyl groups;
R₃′ represents an alkyl radical of 1 to 20 C such as a methyl radical, an alkenyl radical of 10 to 20 C, or an aryl radical of 6 to 20 C such as a phenyl radical; and
R₄′ represents: 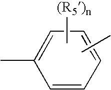
   in which the phenylene group may be in the o, m or p form and in which R₅′ represents a halogen atom (such as F, Cl, Br and I), a (linear or branched) alkyl group containing from 1 to 20 carbon atoms, a cycloalkyl group containing from 3 to 20 carbon atoms (such as methyl, ethyl, propyl, butyl, cyclohexyl), an alkoxy group containing from 1 to 20 carbon atoms (such as methoxy, ethoxy, propoxy), an aryl group containing from 6 to 20 carbon atoms (such as a phenyl group), an aryloxy group containing from 6 to 20 carbon atoms (such as a phenoxy group), a (linear or branched) alkenyl group containing from 2 to 20 carbon atoms, a cycloalkenyl group containing from 3 to 20 carbon atoms (such as vinyl, allyl, cyclohexenyl), an alkynyl group containing from 2 to 20 carbon atoms (such as ethynyl or propargyl), an amino group, an amino group substituted with one or two substituents containing from 2 to 20 carbon atoms (such as dimethylamino, diethylamino, ethylmethylamino, methylphenylamino) or a silanyl group containing from 1 to 10 silicon atoms (such as silyl, disilanyl (—Si₂H₅), dimethylsilyl, trimethylsilyl and tetramethyldisilanyl), one or more hydrogen atoms linked to the carbon atoms of R possibly being replaced with halogen atoms (such as F, Cl, Br and I), alkyl groups, alkoxy groups (such as methoxy, ethoxy and propoxy), aryl groups, aryloxy groups (such as a phenoxy group), amino groups, amino groups substituted with one or two substituents, or silanyl groups; n is an integer from 0 to 4; or R₄′ represents a group containing at least two aromatic nuclei comprising, for example, from 6 to 20 C, linked via at least one covalent bond and/or at least one divalent group; and x and y and z represent, respectively, integers between 0 and 1000.

The poisoned modified polymer according to the invention described by the above formula is the polymer derived from the following (addition) reaction: 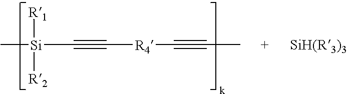
in which k is an integer from 0 to 1000.

Analogous formulae may optionally be deduced for the modified polymers derived from the reaction of the various PEPES polymers listed above with the various compounds containing only one reactive function.

The invention also relates to novel poly(ethynylene phenylene ethynylene silylene) polymers that intrinsically make it possible, by virtue of their macro-molecular structure, to control the contribution of the Diels-Alder mechanism to the formation of the final network of the cured material or product, and thus the crosslinking density of the said cured material or product and consequently the properties and especially the mechanical properties of the material. These novel polymers are referred to as “self-poisoned” polymers to distinguish them from the modified “poisoned” polymers described above.

These novel “self-poisoned” polymers derived from PEPES are designed so as not to allow the Diels-Alder reaction, by virtue precisely of their structure.

These novel “self-poisoned” polymers are based on the same inventive concept as the modified polymers described above, i.e. fundamentally the control, the prohibition and the suppression of the Diels-Alder reactions during the crosslinking of the polymers.

These novel self-poisoned polymers thus provide the problems posed by the polymers of the prior art with a solution of the same nature based on the same principles as the modified polymers described above.

The prohibition of the Diels-Alder reactions may take place by means of the selective addition of monofunctional compounds to PEPES as in the case of the modified polymers according to the invention described above, but it may also be achieved by means of structural units already present in the polymer, which inherently form part of its initial structure, its basic structure; these structural units resulting directly from the polymerization reaction, and not being derived from structural modifications subsequent to the polymerization and from the action, for example, of a monofunctional reactive agent on an already-synthesized polymer.

In these novel self-poisoned polymers, the Diels-Alder reaction may thus be prevented intrinsically in their macromolecular structure (structure derived directly from the polymerization without any other modification), for example by distancing the acetylenic bonds from the aromatic nucleus, by functionalizing this nucleus (by substitution of the protons), or alternatively by replacing the aromatic nucleus with a heterocycle.

These novel “self-poisoned” polymers may be represented by the following formula: 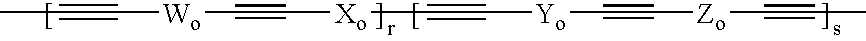
in which:
r and s are integers from 1 to 1000;
Xₒ and Zₒ, which may be identical or different, each independently represent a group α₁, a group α₂ or a combination of these groups:
in which α₁ represents: 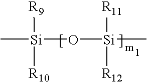
α₂ represents: 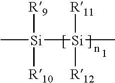
   in which:
m₁ and n₁ are integers generally between 1 and 1000 and preferably between 1 and 10;
R₉, R₁₁, R₁₂, R′₉, R′₁₀, R′₁₁ and R′₁₂, which may be identical or different, each independently represent a hydrogen atom, an alkyl group containing from 1 to 20 carbon atoms, an alkenyl group containing from 2 to 20 carbon atoms, an alkynyl group containing from 2 to 20 carbon atoms or an aryl group containing from 6 to 20 carbon atoms, the hydrogen atoms linked to the carbon atoms of R₉, R₁₀, R₁₁ and R₁₂ and R′₉, R′₁₀, R′₁₁ and R′₁₂ possibly being partially or totally replaced with halogen atoms, alkoxy groups, phenoxy groups, disubstituted amino groups or silanyl groups;
Wₒ and Yₒ, which may be identical or different, each independently represent a group B₁, a group B₂, a group B₃ or a combination of these groups B₁, B₂ and B₃.

Thus, if it is chosen to distance the acetylenic bonds;
Wₒ and Yₒ may represent a group of formula B₁:
   —CH₂ [symbol] O [symbol] ᵢR₁₃ [symbol] O [symbol] ᵢCH₂—
   in which i is an integer equal to 0 or 1 and the group R₁₃ represents any divalent chemical group comprising one or more aromatic or heterocyclic rings or nuclei.

Examples of structures that may represent the group R₁₃ are the following: 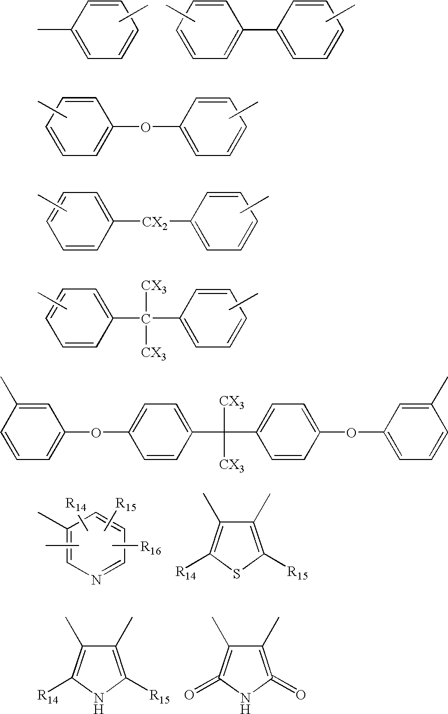
in which X represents a hydrogen atom or a halogen atom (F, Cl, Br or I); and in which R₁₄, R₁₅ and R₁₆, which may be identical or different, have the same meaning as R₉ and each independently represent a hydrogen atom, an alkyl group containing from 1 to 20 carbon atoms, an alkenyl group containing from 2 to 20 carbon atoms, an alkynyl group containing from 2 to 20 carbon atoms or an aryl group containing from 6 to 20 carbon atoms, the hydrogen atoms linked to the carbon atoms of R₁₄, R₁₅ and R₁₆ possibly being partially or totally replaced with halogen atoms, alkoxy groups, phenoxy groups, disubstituted amino groups or silanyl groups;
or Wₒ and Yₒ may represent a group B₂; if the strategy of inhibition of the Diels-Alder mechanism by functionalization of the aromatic ring is adopted, B₂ represents: 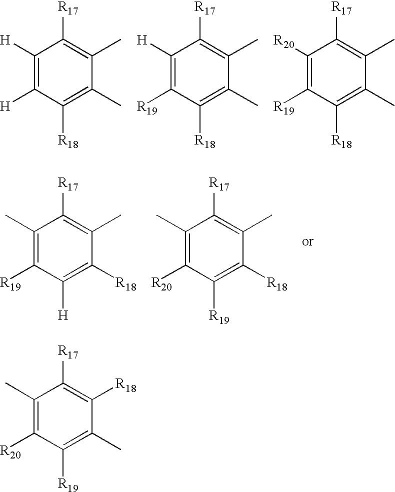
in which R₁₇, R₁₈, R₁₉ and R₂₀, which may be identical or different, each independently represent a halogen atom, an alkyl group containing from 1 to 20 carbon atoms, an alkoxy group containing from 1 to 20 carbon atoms, a phenoxy group containing from 6 to 20 carbon atoms, an aryl group containing from 6 to 20 carbon atoms, a substituted amino group containing from 2 to 20 carbon atoms or a silanyl group containing from 1 to 10 carbon atoms, the hydrogen atoms linked to the carbon atoms of the substituents R₁₇, R₁₈, R₁₉ and R₂₀ possibly being totally or partially replaced with halogen atoms, alkoxy groups, phenoxy groups, disubstituted amino groups or silanyl groups;
or alternatively Wₒ and Yₒ may represent a group B₃ chosen from divalent heterocycles.

Examples of these heterocycles have already been given above in the context of the definition of the group R₁₃ of B₁.

Several strategies may be combined in the same polymer by selecting Wₒ and Yₒ from different groups B₁, B₂ and B₃.

A “self-poisoned” polymer that is particularly advantageous is poly(ethynylene mesitylene ethynylene silylene), the repeating unit of which corresponds to the formula: 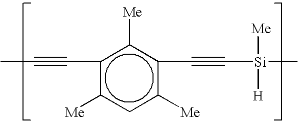
or poly(ethynylene tetrafluorophenylene ethynylene silylene), the repeating unit of which corresponds to the formula:

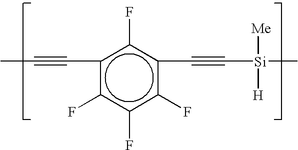

These polymers are obtained, respectively, from 1,3-diethynylmesitylene: 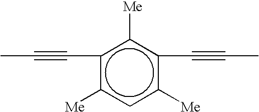
and 1,3-diethynyl-2,4,5,6-tetrafluorobenzene:

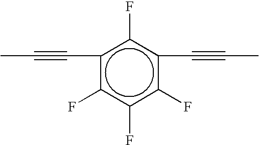

These self-poisoned polymers may be prepared via known processes for preparing polymers of this type described in the prior art documents described above, by appropriately selecting the starting compounds so as to obtain the specific groups Wₒ, Xₒ, Yₒ and Zₒ incorporated into the structure of these cured polymers. It should be noted, however, that these “self-poisoned” polymers are generally prepared without the need for a catalyst, which allows their structure to be controlled.

The invention also relates to the cured product that may be obtained by heat treatment at a temperature generally of from 50 to 500° C. of the modified, poisoned polymers or of the novel “self-poisoned” polymers according to the invention, described above, optionally in the presence of a catalyst, such as a Diels-Alder and/or hydrosilylation reaction catalyst.

The “self-poisoned” polymers according to the invention may advantageously be cured without a catalyst. This fact that an uncatalysed system can generally be used to cure the self-poisoned polymers according to the invention is one of their advantages. The absence of catalyst ensures greater ease of processing and easier storage prior to curing; it is possible for the user to control the curing reaction better, by virtue of the absence of catalyst.

In other words, the “self-poisoned” polymers according to the invention have several appreciable advantages not only in the context of their synthesis but also of their curing, when compared with the modified polymers according to the invention; specifically, their catalyst-free synthesis is better controlled, their structure ensures better control of the degree of poisoning and the absence of catalyst during curing also allows better control of this curing and easy processing by the user.

Finally, the invention also relates to a composite matrix comprising the modified polymer or the novel self-poisoned polymer described above.

The cured products prepared by heat treatment of the poisoned modified polymers or of the novel self-poisoned polymers, according to the invention, are, for example, produced by melting the polymer by generally bringing it to a temperature of from 30 to 200° C.

Next, the polymer melt is formed as desired, for example by pouring the polymer melt into a mould having the desired form.

The polymer cast in the mould is then degassed, under vacuum, for example at from 0.1 to 10 mbar for a time, for example, of from 10 minutes to 6 hours, and at a temperature of from 30 to 200° C.

After degassing, the system is returned to atmospheric pressure while generally conserving the same temperature, and the actual crosslinking is performed by heating the mould and the polymer in a gaseous atmosphere, for example in a gaseous atmosphere of air, nitrogen or an inert gas such as argon or helium.

The treatment temperature generally ranges from 50 to 500° C., preferably from 100 to 400° C. and more preferably from 150 to 350° C., and the heating is generally performed for a time of from 1 minute to 100 hours and preferably from 2 to 12 hours.

As a result of the analogous structure of the polymers, according to the invention, and of the polymers of document EP-B1-0 617 073, their curing process is substantially identical and reference may be made to page 17 of the said document, and also to document FR-A-2 798 622, for further details.

The nature and structure of the cured products or materials obtained depend on the modified (“poisoned”) or self-poisoned poly(ethynylene phenylene ethynylene silylene) polymer(s) used. The crosslinking treatment may comprise a certain number of steps consisting of a succession of temperature rises from a starting temperature that is generally the temperature at which the degassing was performed, up to a final temperature that is the crosslinking temperature. Steady temperature stages are observed after each rise in temperature and a final steady stage is observed at the cross-linking temperature, which is, for example, from 250 to 450° C. and which is maintained for 1 (or 2) to 12 hours.

After the final steady stage, the temperature is generally gradually reduced to room temperature, for example at a rate of from 0.1 to 5° C./minute.

A typical crosslinking cycle may be, for example, as follows:
the temperature is raised from room temperature to 180° C., and a steady stage or isotherm of 2 hours at 180° C. is observed;
the temperature is raised from 180° C. to 240° C., and a steady stage or isotherm of 2 hours at 240° C. is observed;
the temperature is raised from 240° C. to 300° C. and a steady stage or isotherm of 2 hours at 300° C. is observed;
the temperature is reduced from 300° C. to room temperature.

All the temperature rise and fall gradients take place at a rate of 1° C./minute.

The advantages presented by the crosslinked cured products according to the invention have already been described above. These advantages are inherently associated with the modified or self-poisoned polymers according to the invention from which these cured products are derived.

These cured products have excellent thermal properties, which are at least equivalent to those of the cured products obtained under the same conditions from the polymers, for example the unmodified, unpoisoned, non-self-poisoned polymers, of the prior art, and mechanical properties that are markedly improved compared with the mechanical properties of the cured products obtained from the polymers (for example the unmodified polymers) of the prior art.

The properties of these cured products may moreover be perfectly and precisely modified by means of controlling the crosslinking density, afforded by modifying or poisoning the polymer or by the specific structure of this polymer in the case of the “self-poisoned” polymers.

The improved mechanical properties are in particular demonstrated by means of the substantially superior modulus of elasticity, breaking stress and breaking strain values.

The preparation of composites with an organic matrix comprising the polymer of the invention may be performed via numerous techniques.

Each user adapts it to his constraints. The principle is generally always the same: namely, impregnation of a textile reinforcing agent with the resin, followed by crosslinking by heat treatment comprising a rate of temperature increase of a few degrees/minute and then a steady stage close to the crosslinking temperature.

The invention will now be described with reference to the following examples, which are given as non-limiting illustrations.

### EXAMPLES

### Example 1

### Preparation of poly(dimethylsilylene-ethynylene-phenylene-ethynylene) Poisoned with 20% by Mass of dimethylphenylsilane

100 g of poly(dimethylsilylene-ethynylene-phenylene-ethynylene) are introduced into a 1 litre three-necked round-bottomed flask placed under argon. The flask is heated to 100° C. to lower the viscosity of the polymer. 25 g of dimethylphenylsilane are then introduced into the flask. Once the mixture is homogeneous, 0.5 ml of Pt-TVTS at 0.1M in THF is added dropwise. The system is maintained at the same temperature and under argon for 2 hours. The modified polymer is then passed onto a rotary evaporator to ensure that no free poisoning agent remains (90° C., 0.1 mbar). The grafting is quantitative and may be verified by ¹H NMR.

### Example 2

### Preparation of poly(methylhydrosilylene-ethynylene-phenylene-ethynylene) Poisoned with 20% by Mass of dimethylphenylsilane

100 g of poly(methylhydrosilylene-ethynylene-phenylene-ethynylene) are introduced into a 1 litre three-necked round-bottomed flask placed under argon. 25 g of dimethylphenylsilane are then introduced into the flask. If the viscosity of the polymer allows it, homogenization is performed at room temperature. If this is difficult, the temperature of the flask is raised to 50° C. to facilitate mixing and the system is then kept stirring while allowing it to cool to room temperature. 250 μl of PT-TVTS catalyst at 0.1M in THF are then introduced dropwise into the flask with vigorous stirring.

The system is then degassed slightly (50° C., 10 minutes, under 10 mbar) and can then undergo the crosslinking cycle detailed hereinbelow (Example 4).

### Example 3

### Crosslinking of poly(dimethylsilylene-ethynylene-phenylene-ethynylene) Poisoned with 20% by Mass of dimethylphenylsilane

The poisoned polymer obtained in Example 1 is brought to 120° C. and poured into the cavities of a metallic or silicone mould and then degassed under 0.2 mbar at 120° C. for 15 minutes. After returning to atmospheric pressure, the crosslinking cycle below is initiated under air: from 120 to 200° C. over 8 minutes, then 1 hour at 200° C., then from 200 to 250° C. over 25 minutes, then 2 hours at 250° C., then from 250 to 300° C. over 25 minutes, then 2 hours at 300° C., then from 300° C. to 25° C. over 3 hours.

Such a material has, in bending and at 20° C., a modulus of elasticity of about 2.7 GPa, a breaking stress of about 60 MPa, and a breaking strain of about 2.2%.

The bending tests are tests of three-point bending with 70×15×3 mm³ specimens, a centre-to-centre spacing of 48 mm and a travelling speed of 1 mm/minute.

By way of comparison, the material obtained from the same unmodified, unpoisoned polymer, crosslinked under the same conditions, has, in bending and at 20° C., a modulus of elasticity of about 2.2 GPa, a breaking stress of about 19 MPa and a breaking strain of about 0.9%.

### Example 4

### Crosslinking of poly(methylhydrosilylene-ethynylene-phenylene-ethynylene) Poisoned with 20% by Mass of dimethylphenylsilane

The poisoned polymer obtained in Example 2 is brought to 40-50° C. and poured into the cavities of a metal or silicone mould and then degassed under 40 mbar at 50° C. for 10 minutes. After returning to atmospheric pressure, the following crosslinking cycle is initiated under air: from 50 to 100° C. over 50 minutes, then 1 hour at 100° C., then from 100 to 150° C. over 50 minutes, then 1 hour at 150° C., then from 150 to 200° C. over 25 minutes, then 1 hour at 200° C., then from 200 to 250° C. over 25 minutes, then 1 hour at 250° C., then from 250 to 300° C. over 25 minutes, then 2 hours at 300° C., then from 300° C. to 25° C. over 3 hours.

Such as material has, in bending and at 20° C., a modulus of elasticity of about 2.8 GPa, a breaking stress of about 50 MPa and a breaking strain of about 1.8%.

The conditions of the bending tests are detailed above (Example 3).

By way of comparison, the material obtained from the same unmodified, unpoisoned polymer, crosslinked under the same conditions, has, in bending and at 20° C., a modulus of elasticity of about 2.8 GPa, a breaking stress of about 22 MPa and a breaking strain of about 0.9%.

### Example 5

### Preparation of poly(ethynylene-mesitylene-ethynylene-silylene): “Self-Poisoned” Polymer According to the Invention

The polymer is obtained according to the method described, for example, in document FR-A-2 798 662, replacing the diethynyl benzene with diethynylmesitylene. The latter compound is obtained by deprotection of 1,3-bis(trimethylsilylethynyl)mesitylene, which is itself obtained by catalytic coupling of 1,3-diisobismesitylene with two equivalents of trimethylsilylacetylene.

### REFERENCES

[1] “New Highly Heat-Resistant Polymers containing Silicon : Poly(silyleneethynylenephenylene ethynylene)s” by ITOH M., INOUE K., IWATA K., MITSUZUKA M. and KAKIGANO T., Macromolecules, 1997, 30, pp. 694-701.
CORRIU Robert J. P. et al., Journal of polymer science : Part C : Polymer Letters, 1990, 28, pp. 431-437.
“Copper [I] chloride catalyzed cross dehydrocoupling reactions between silanes and ethynyl compounds. A new method for the copolymerization of silanes and alkynes” by Lu H. Q.; HARROD J. F. The Canadian Journal of Chemistry, 1990, vol. 68, pp. 1100-1105.
“A novel synthesis and extremely high Thermal stability of Poly[(phenylsilylene)-(ethynylene-1,3-phenylene ethynylene)]” by ITOH M., INOUE K., IWATA K., MITSUZUKA M., KAKIGANO T. Macromolecules, 1994, 27, pp. 7917-7919.
KUROKI S.; OKITA K.; KAKIGANO T.; ISHIKAWA J. ITOH M.; Macromolecules, 1998, 31, 2804-2808.

1. Modified poly(ethynylene phenylene ethynylene silylene) polymer obtainable by selective addition of a compound containing only one reactive function on the acetylenic bonds of a poly(ethynylene phenylene ethynylene silylene) polymer.

2. The modified polymer according to claim 1, in which the compound containing only one reactive function is chosen from compounds whose sole reactive function is a hydrogen.

3. The modified polymer according to claim 2, in which the compound is chosen from monohydrogenated siliceous compounds.

4. The modified polymer according to claim 3, in which the monohydrogenated siliceous compound is a monohydrogenated silane corresponding to the following formula: 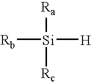
in which Rₐ, R_{b} and R_{c}, which may be identical or different, each independently represent an alkyl radical of 1 to 20 C such as a methyl radical, an alkenyl radical of 2 to 20 C, or an aryl radical of 6 to 20 C such as a phenyl radical.

5. The modified polymer according to claim 3, in which the monohydrogenated siliceous compound is a monohydrogenated siloxane corresponding to the following formula: 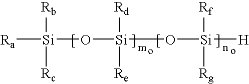
in which Rₐ, R_{b}, R_{c}, R_{d}, Rₑ, R_{f} and R_{g}, which may be identical or different, each independently represent an alkyl radical of 1 to 20 C such as a methyl radical, an alkenyl radical of 2 to 20 C, or an aryl radical of 6 to 20 C such as a phenyl radical, and nₒ and mₒ represent an integer from 0 to 1000.

6. The modified polymer according to claim 3, in which the monohydrogenated siliceous compound is a monohydrogenated silsesquioxane corresponding to the following formula: 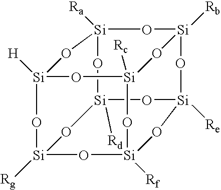
in which Rₐ, R_{b}, R_{C}, R_{d}, Rₑ, R_{f} and R_{g}, which may be identical or different, each independently represent an alkyl radical of 1 to 20 C such as a methyl radical, an alkenyl radical of 2 to 20 C, or an aryl radical of 6 to 20 C such as a phenyl radical.

7. The modified polymer according to any one of claims 1 to 6, in which the addition is performed in the presence of a catalyst.

8. The modified polymer according to claim 7, in which the catalyst is a hydrosilylation reaction catalyst preferably chosen from platinum-based catalysts, such as H₂PtCl₆, Pt(DVDS), Pt(TVTS), Pt(dba), in which DVDS represents divinyldisiloxane, TVTS represents trivinyltrisiloxane and dba represents dibenzylideneacetone; and transition metal complexes, such as Rh₆(C0)₁₆ or Rh₄(C0)₁₂, C1Rh(PPh₃), Ir₄(C0)₁₂ and Pd(dba).

9. The modified polymer according to claim 1, in which the addition is performed at a temperature of from −20° C. to 200° C. and preferably from said 30 to 150° C.

10. The modified polymer according to claim 1, in which the compound represents from 0.1% to 75%.

11. The modified polymer according to claim 1, in which the selective addition is performed under an atmosphere of an inert gas such as argon.

12. The modified polymer according to claim 1, in which the poly (ethynylene phenylene ethynylene silylene) PEPES polymer corresponds to formula (I) below: 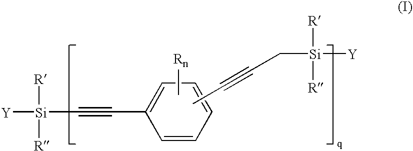
or to formula (Ia) below: 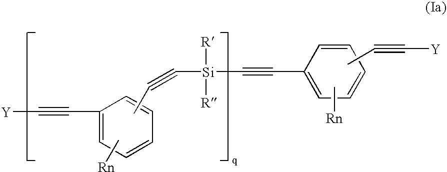
in which the phenylene group of the central repeating unit may be in the o, m or p form; R represents a halogen atom (such as F, Cl, Br and I), an alkyl group (linear or branched) containing from 1 to 20 carbon atoms, a cycloalkyl group containing from 3 to 20 carbon atoms (such as methyl, ethyl, propyl, butyl, cyclohexyl), an alkoxy group containing from 1 to 20 carbon atoms (such as methoxy, ethoxy, propoxy), an aryl group containing from 6 to 20 carbon atoms (such as a phenyl group), an aryloxy group containing from 6 to 20 carbon atoms (such as a phenoxy group), an alkenyl group (linear or branched) containing from 2 to 20 carbon atoms, a cycloalkenyl group containing from 3 to 20 carbon atoms (such as vinyl, allyl, cyclohexenyl), an alkynyl group containing from 2 to 20 carbon atoms (such as ethynyl, propargyl), an amino group, an amino group substituted with one or two substituents containing from 2 to 20 carbon atoms (such as dimethylamino, diethylamino, ethylmethylamino, methylphenylamino) or a silanyl group containing from 1 to 10 silicon atoms (such as silyl, disilanyl (—Si₂H₅), dimethylsilyl, trimethylsilyl and tetramethyldisilanyl), one or more hydrogen atoms linked to the carbon atoms of R, may be replaced with halogen atoms (such as F, Cl, Br and I), alkyl groups, alkoxy groups (such as methoxy, ethoxy and propoxy), aryl groups, aryloxy groups (such as a phenoxy group), amino groups, amino groups substituted with one or two substituents or silanyl groups; n is an integer from 0 to 4 and q is an integer from 1 to 1000, for example from 1 to 40; R′ and R″, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, an alkynyl group containing from 2 to 20 carbon atoms, one or more of the hydrogen atoms linked to the carbon atoms of R′ and R″ possibly being replaced with halogen atoms, alkyl groups, alkoxy groups, aryl groups, aryloxy groups, amino groups, disubstituted amino groups or silanyl groups; examples of these groups have already been mentioned above for R; and Y represents a group derived from a chain-limiting agent.

13. The modified polymer according to claim 12, in which the PEPES polymer corresponds to formula (I) and Y represents a group of formula (III): 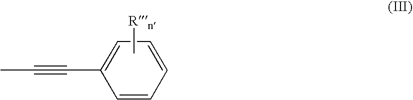
in which R′″ has the same meaning as R and may be identical to or different from the latter, and n′ has the same meaning as n and may be identical to or different from the latter.

14. The modified polymer according to claim 13, in which the PEPES polymer corresponds to formula (Ia) and Y represents a group of formula (IV): 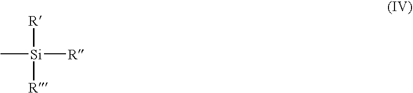
in which R′, R″ and R′″, which may be identical or different.

15. The modified polymer according to claim 12, in which the PEPES polymer corresponds to the following formula: 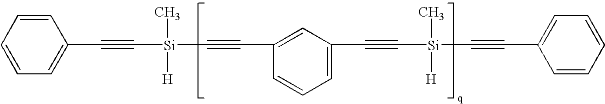
in which q is an integer from 1 to 1000.

16. The modified polymer according to claim 15, in which the PEPES polymer is a polymer of determined molecular mass, which may be obtained (which is obtainable) by hydrolysis of a polymer of formula (Ia) and which corresponds to formula (Ib) below.

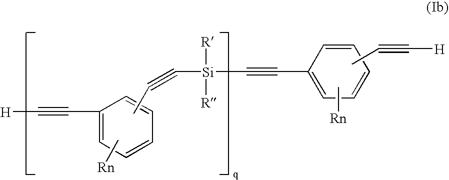

17. The modified polymer according to claim 12, in which the PEPES polymer has a molar ratio of the groups Y at the end of the chain to the ethynylene phenylene ethynylene silylene repeating units of from 0.002 to 2 and preferably from 0.1 to 1.

18. The modified polymer according to claim 16, in which the number-average molecular mass of polymers (I), (Ia) and (Ib) is from 400 to 10000, and the weight-average molecular mass is from 600 to 20 000.

19. The modified polymer according to claim 1, in which the poly(ethynylene phenylene ethynylene silylene) (PEPES) polymer is a polymer comprising at least one repeating unit, the repeating unit comprising two acetylenic bonds, at least one silicon atom and at least one inert spacer group.

20. The modified polymer according to claim 19, in which the polymer also comprises groups (Y) derived from a chain-limiting agent.

21. The modified polymer according to claim 19, in which the inert spacer group of the polymer does not participate during crosslinking.

22. The modified polymer according to claim 19, in which the spacer group(s) of the polymer is (are) chosen from groups comprising several aromatic nuclei linked via at least one covalent bond and/or at least one divalent group, polysiloxane groups, polysilane groups and all possible combinations of two or more of these groups.

23. The modified polymer according to claim 19, in which the PEPES polymer is a polymer comprising a repeating unit of formula (V); 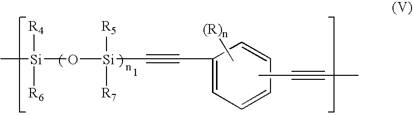
in which the phenylene group of the central repeating unit may be in the o, m or p form; R represents a halogen atom (such as F, Cl, Br and I), an alkyl group (linear or branched) containing from 1 to 20 carbon atoms, a cycloalkyl group containing from 3 to 20 carbon atoms (such as methyl, ethyl, propyl, butyl, cyclohexyl), an alkoxy group containing from 1 to 20 carbon atoms (such as methoxy, ethoxy, propoxy), an aryl group containing from 6 to 20 carbon atoms (such as a phenyl group), an aryloxy group containing from 6 to 20 carbon atoms (such as a phenoxy group), an alkenyl group (linear or branched) containing from 2 to 20 carbon atoms, a cycloalkenyl group containing from 3 to 20 carbon atoms (such as vinyl, allyl, cyclohexenyl), an alkynyl group containing from 2 to 20 carbon atoms (such as ethynyl, propargyl), an amino group, an amino group substituted with one or two substituents containing from 2 to 20 carbon atoms (such as dimethylamino, diethylamino, ethylmethylamino, methylphenylamino) or a silanyl group containing from 1 to 10 silicon atoms (such as silyl, disilanyl (—Si₂H₅), dimethylsilyl, trimethylsilyl and tetramethyldisilanyl), one or more hydrogen atoms linked to the carbon atoms of R, may be replaced with halogen atoms (such as F, Cl, Br and I), alkyl groups, alkoxy groups (such as methoxy, ethoxy and propoxy), aryl groups, aryloxy groups (such as a phenoxy group), amino groups, amino groups substituted with one or two substituents or silanyl groups; R₄, R₅, R₆ and R₇, which may be identical or different, represent a hydrogen atom; an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, an alkynyl group containing from 2 to 20 carbon atoms, one or more of the hydrogen atoms linked to the carbon atoms of R₄, R₅, R₆ and R₇ possibly being replaced with halogen atoms, alkyl groups, alkoxy groups, aryl groups, aryloxy groups, amino groups, disubstituted amino groups or silanyl groups; examples of these groups have already been mentioned above for R, n is an integer from 0 to 4, and n₁ is an integer from 1 to 10 and preferably from 1 to 4; this repeating unit is generally repeated n₃ times, with n₃ being an integer, for example from 2 to 1000.

24. The modified polymer according to claim 19, in which the PEPES polymer is a polymer comprising a repeating unit of formula: 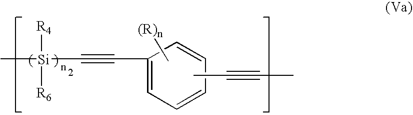
in which the phenylene group may be in the o, m or p form, R represents a halogen atom (such as F, Cl, Br and I), an alkyl group (linear or branched) containing from 1 to 20 carbon atoms, a cycloalkyl group containing from 3 to 20 carbon atoms (such as methyl, ethyl, propyl, butyl, cyclohexyl), an alkoxy group containing from 1 to 20 carbon atoms (such as methoxy, ethoxy, propoxy), an aryl group containing from 6 to 20 carbon atoms (such as a phenyl group), an aryloxy group containing from 6 to 20 carbon atoms (such as a phenoxy group), an alkenyl group (linear or branched) containing from 2 to 20 carbon atoms, a cycloalkenyl group containing from 3 to 20 carbon atoms (such as vinyl, allyl, cyclohexenyl), an alkynyl group containing from 2 to 20 carbon atoms (such as ethynyl, propargyl), an amino group, an amino group substituted with one or two substituents containing from 2 to 20 carbon atoms (such as dimethylamino, diethylamino, ethylmethylamino, methylphenylamino) or a silanyl group containing from 1 to 10 silicon atoms (such as silyl, disilanyl (—Si₂H₅), dimethylsilyl, trimethylsilyl and tetramethyldisilanyl), one or more hydrogen atoms linked to the carbon atoms of R, may be replaced with halogen atoms (such as F, Cl, Br and I), alkyl groups, alkoxy groups (such as methoxy ethoxy and propoxy), aryl groups, aryloxy groups (such as a phenoxy group), amino groups, amino groups substituted with one or two substituents or silanyl groups; R₄, and R₆, which may be identical or different, represent a hydrogen atom; an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, an alkynyl group containing from 2 to 20 carbon atoms, one or more of the hydrogen atoms linked to the carbon atoms of R₄, and R₆ possibly being replaced with halogen atoms, alkyl groups, alkoxy groups, aryl groups, aryloxy groups, amino groups, disubstituted amino groups or silanyl groups; examples of these groups have already been mentioned above for R, n is an integer from 0 to 4, and n₂ is an integer from 2 to 10.

25. The modified polymer according to claim 19, in which the PEPES polymer is a polymer comprising a repeating unit of formula: 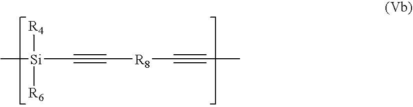
in which R₄ and R₆, which may be identical or different, represent a hydrogen atom; an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, an alkynyl group containing from 2 to 20 carbon atoms, one or more of the hydrogen atoms linked to the carbon atoms of R₄, and R₆ possibly being replaced with halogen atoms, alkyl groups, alkoxy groups, aryl groups, aryloxy groups, amino groups, disubstituted amino groups or silanyl groups; and R₈ represents a group comprising at least two aromatic nuclei comprising, for example, from 6 to 20 C, linked via at least one covalent bond and/or at least one divalent group.

26. The modified polymer according to claim 19, in which the PEPES polymer is a polymer comprising a repeating unit of formula: 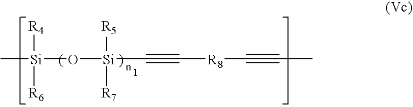
in which R₄, R₅, R₆ and R₇, which may be identical or different, represent a hydrogen atom: an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, an alkynyl group containing from 2 to 20 carbon atoms, one or more of the hydrogen atoms linked to the carbon atoms of R₄, R₅, R₆ and R₇ possibly being replaced with halogen atoms, alkyl groups, alkoxy groups, aryl groups, aryloxy groups, amino groups, disubstituted amino groups or silanyl groups; R₈ represents a group comprising at least two aromatic nuclei comprising, for example, from 6 to 20 C, linked via at least one covalent bond and/or at least one divalent group, and n₁ is an integer from 1 to 10 and preferably from 1 to 4.

27. The modified polymer according to claim 19, in which the polymer is a polymer comprising a repeating unit of formula: 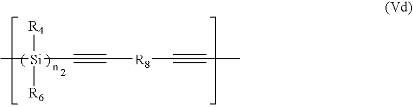
in which R₄, and R₆, which may be identical or different, represent a hydrogen atom; an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, an alkynyl group containing from 2 to 20 carbon atoms, one or more of the hydrogen atoms linked to the carbon atoms of R₄, and R₆, possibly being replaced with halogen atoms, alkyl groups, alkoxy groups, aryl groups, aryloxy groups, amino groups, disubstituted amino groups or silanyl groups; R₈ represents a group comprising at least two aromatic nuclei comprising, for example, from 6 to 20 C, linked via at least one covalent bond and/or at least one divalent group, and n₂ is an integer from 2 to 10.

28. The modified polymer according to any one of claims 25 to 27, in which the group R₈ of the PEPES polymer is chosen from the following groups: 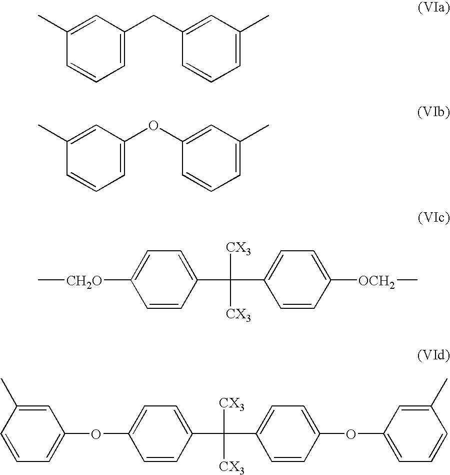
in which X represents a hydrogen atom or a halogen atom (F, Cl, Br or I).

29. The modified polymer according to claim 19, in which the PEPES polymer comprises a repeating unit repeated n₃ times, with n₃ being an integer, for example from 2 to 1000.

30. The modified polymer according to claim 19, in which the polymer comprises several different repeating units comprising at least one inert spacer group.

31. The modified polymer according to claim 30, in which the said repeating units of the polymer, comprising at least one inert spacer group, are chosen from the repeating units of formulae: 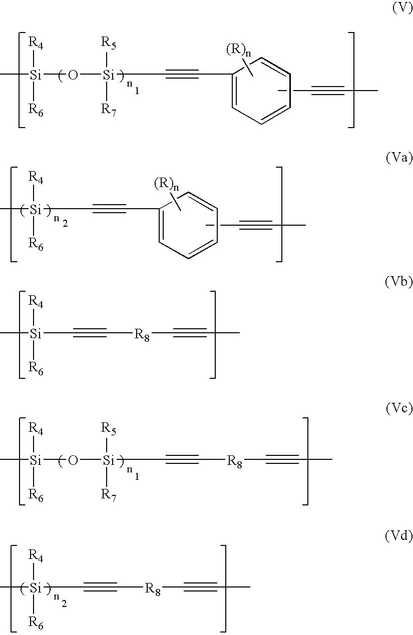
in which the phenylene group of the central repeating unit may be in the o, m or p form, R represents a halogen atom (such as F, Cl, Br and I), an alkyl group (linear or branched) containing from 1 to 20 carbon atoms, a cycloalkyl group containing from 3 to 20 carbon atoms (such as methyl, ethyl, propyl, butyl, cyclohexyl), an alkoxy group containing from 1 to 20 carbon atoms (such as methoxy, ethoxy, propoxy), an aryl group containing from 6 to 20 carbon atoms (such as a phenyl group), an aryloxy group containing from 6 to 20 carbon atoms (such as a phenoxy group), an alkenyl group (linear or branched) containing from 2 to 20 carbon atoms, a cycloalkenyl group containing from 3 to 20 carbon atoms (such as vinyl, allyl, cyclohexenyl), an alkynyl group containing from 2 to 20 carbon atoms (such as ethynyl, propargyl), an amino group, an amino group substituted with one or two substituents containing from 2 to 20 carbon atoms (such as dimethylamino, diethylamino, ethylmethylamino, methylphenylamino) or a silanyl group containing from 1 to 10 silicon atoms (such as silyl, disilanyl (—Si₂H₅), dimethylsilyl, trimethylsilyl and tetramethyldisilanyl), one or more hydrogen atoms linked to the carbon atoms of R, may be replaced with halogen atoms (such as F, Cl, Br and I), alkyl groups, alkoxy groups (such as methoxy ethoxy and propoxy), aryl groups, aryloxy groups (such as a phenoxy group), amino groups, amino groups substituted with one or two substituents or silanyl groups; R₄, R₅, R₆ and R₇, which may be identical or different, represent a hydrogen atom; an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, an alkynyl group containing from 2 to 20 carbon atoms, one or more of the hydrogen atoms linked to the carbon atoms of R₄, R₅, R₆ and R₇ possibly being replaced with halogen atoms, alkyl groups, alkoxy groups, aryl groups, aryloxy groups, amino groups, disubstituted amino groups or silanyl groups; examples of these groups have already been mentioned above for R, n is an integer from 0 to 4; R₈ represents a group comprising at least two aromatic nuclei comprising, for example, from 6 to 20 C, linked via at least one covalent bond and/or at least one divalent group; n₁ is an integer from 1 to 10 and preferably from 1 to 4; n₂ is an integer from 2 to 10; and n₃ is an integer, for example from 2 to 1000.

32. The modified polymer according to claim 31, in which the repeating units of the polymer are repeated x₁, x₂, x₃, x₄ and x₅ times, respectively, x₁ x₂, x₃, x₄ and x₅ representing integers from 0 to 100000, on condition that at least two from among x₁, x₂, x₃, x₄ and x₅ are other than 0.

33. The modified polymer according to claim 19, in which the polymer also comprises one or more repeating units not comprising an inert spacer group.

34. The modified polymer according to claim 33, in which the repeating unit of the polymer, which does not comprise an inert spacer group, corresponds to the formula:

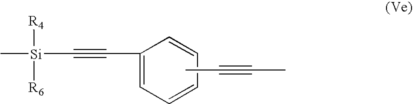

35. The modified polymer according to claim 33 or 34, in which the repeating unit of the polymer, not comprising an inert spacer group, is repeated x₆ times, x₆ representing an integer from 0 to 100000.

36. The modified polymer according to claim 30, in which the polymer corresponds to the formula: 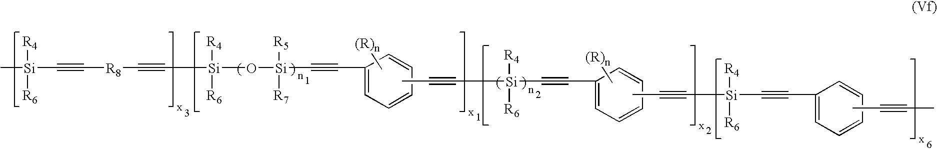
in which x₁, x₂, x₃ and x₆ are integers from 0 to 100000, on condition that at least two from among x₁, x₂ and x₃ are other than 0.

37. The modified polymer according to claim 30, in which the polymer has a number-average molecular mass of from 400 to 10 000 and a weight-average molecular mass of from 500 to 1 000 000.

38. A Process for preparing a modified poly(ethynylene phenylene ethynylene silylene) polymer by selective addition of a compound containing only one reactive function on the acetylenic bonds of a poly(ethynylene phenylene ethynylene silylene) polymer, in which the following successive steps are performed:
a) a poly(ethynylene phenylene ethynylene silylene) (PEPES) polymer is introduced into a reactor;
b) a compound containing only one reactive function is added to the said PEPES;
c) the said PEPES and the said compound are mixed together homogeneously; a catalyst may optionally be added to the reactor either during step b), in the form of a mixture of the catalyst and of the compound containing only one reactive function, or after step c);
d) the compound, the PEPES and the optional catalyst are left in contact until the selective addition of the compound containing only one reactive function to the acetylenic bonds of the PEPES polymer is complete;
e) the modified polymer thus formed is recovered.

39. The process according to claim 38, in which the compound containing only one reactive function is a compound chosen from compounds whose sole reactive function is hydrogen.

40. The process according to claim 38, in which a catalyst is added to the reactor, either during step b) in the form of a mixture of the catalyst and of the compound containing only one reactive function, or to the mixture of the PEPES and of the compound containing only one reactive function after step c).

41. The process according to claim 40, in which the catalyst is a hydrosilylation reaction catalyst preferably chosen from platinum-based catalysts, such as H₂PtCl₆, Pt(DVDS), Pt(TVTS), Pt(dba), in which DVDS represents divinyldisiloxane, TVTS represents trivinyltrisiloxane and dba represents dibenzylideneacetone; and transition metal complexes, such as Rh₆ (CO)₁₆ or Rh₄ (CO)₁₂ C1Rh(PPh₃) Ir₄ (CO)₁₂ and Pd (dba).

42. The process according to claim 38, in which the poly(ethynylene phenylene ethynylene silylene) polymer PEPES corresponds to formula (I) below: 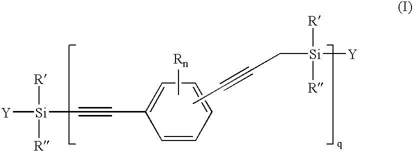
or to formula (Ia) below: 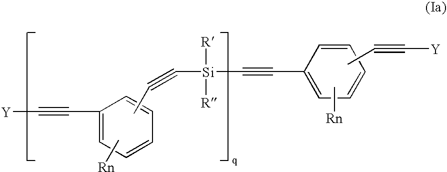
in which the phenylene group of the central repeating unit may be in the o, m or p form; R represents a halogen atom (such as F, Cl, Br and I), an alkyl group (linear or branched) containing from 1 to 20 carbon atoms, a cycloalkyl group containing from 3 to 20 carbon atoms (such as methyl, ethyl, propyl, butyl, cyclohexyl), an alkoxy group containing from 1 to 20 carbon atoms (such as methoxy, ethoxy, propoxy), an aryl group containing from 6 to 20 carbon atoms (such as a phenyl group), an aryloxy group containing from 6 to 20 carbon atoms (such as a phenoxy group), an alkenyl group (linear or branched) containing from 2 to 20 carbon atoms, a cycloalkenyl group containing from 3 to 20 carbon atoms (such as vinyl, allyl, cyclohexenyl), an alkynyl group containing from 2 to 20 carbon atoms (such as ethynyl, propargyl), an amino group, an amino group substituted with one or two substituents containing from 2 to 20 carbon atoms (such as dimethylamino, diethylamino, ethylmethylamino, methylphenylamino) or a silanyl group containing from 1 to 10 silicon atoms (such as silyl, disilanyl (—Si₂H₅), dimethylsilyl, trimethylsilyl and tetramethyldisilanyl), one or more hydrogen atoms linked to the carbon atoms of R, may be replaced with halogen atoms (such as F, Cl, Br and I), alkyl groups, alkoxy groups (such as methoxy, ethoxy and propoxy), aryl groups, aryloxy groups (such as a phenoxy group), amino groups, amino groups substituted with one or two substituents or silanyl groups; n is an integer from 0 to 4 and q is an integer from 1 to 1000, for example from 1 to 40; R′ and R″, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, an alkynyl group containing from 2 to 20 carbon atoms, one or more of the hydrogen atoms linked to the carbon atoms of R′ and R″ possibly being replaced with halogen atoms, alkyl groups, alkoxy groups, aryl groups aryloxy groups, amino groups disubstituted amino groups or silanyl groups; examples of these groups have already been mentioned above for R; and Y represents a group derived from a chain-limiting agent.

43. The process according to claim 38, in which steps b) to c) and d) are performed with stirring.

44. The process according to claim 38, in which the process is performed at a temperature of from −20° C. to 200° C.

45. The process according to claim 38, in which the process is performed under an atmosphere of an inert gas such as argon.

46. The process according to claim 38, in which, in step d), the PEPES, the compound and the optional catalyst are left in contact for a time of from 0.1 to 24 hours, preferably from 0.5 to 8 hours and more preferably from 2 to 6 hours.

47. A composition comprising a poly(ethynylene phenylene ethynylene silylene) polymer, a compound containing only one reactive function and, optionally, a catalyst.

48. The composition according to claim 47, in which the compound containing only one reactive function is a compound chosen from compounds whose sole reactive function is hydrogen.

49. The composition according to claim 47, in which the poly(ethynylene phenylene ethynylene silylene) polymer PEPES corresponds to formula (I) below: 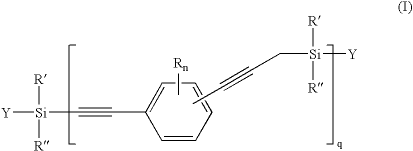
or to formula (Ia) below: 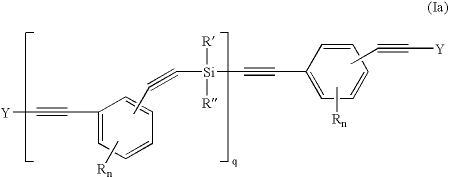
in which the phenylene group of the central repeating unit may be in the o, m or p form; R represents a halogen atom (such as F, Cl, Br and I), an alkyl group (linear or branched) containing from 1 to 20 carbon atoms, a cycloalkyl group containing from 3 to 20 carbon atoms (such as methyl, ethyl, propyl, butyl, cyclohexyl), an alkoxy group containing from 1 to 20 carbon atoms (such as methoxy, ethoxy, propoxy), an aryl group containing from 6 to 20 carbon atoms (such as a phenyl group), an aryloxy group containing from 6 to 20 carbon atoms (such as a phenoxy group), an alkenyl group (linear or branched) containing from 2 to 20 carbon atoms, a cycloalkenyl group containing from 3 to 20 carbon atoms (such as vinyl, allyl, cyclohexenyl), an alkynyl group containing from 2 to 20 carbon atoms (such as ethynyl, propargyl), an amino group, an amino group substituted with one or two substituents containing from 2 to 20 carbon atoms (such as dimethylamino, diethylamino, ethylmethylamino, methylphenylamino) or a silanyl group containing from 1 to 10 silicon atoms (such as silyl, disilanyl (—Si₂H₅), dimethylsilyl, trimethylsilyl and tetramethyldisilanyl), one or more hydrogen atoms linked to the carbon atoms of R, may be replaced with halogen atoms (such as F, Cl, Br and I), alkyl groups, alkoxy groups (such as methoxy, ethoxy and propoxy), aryl groups, aryloxy groups (such as a phenoxy group), amino groups, amino groups substituted with one or two substituents or silanyl groups; n is an integer from 0 to 4 and q is an integer from 1 to 1000, for example from 1 to 40; R′ and R″, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, an alkynyl group containing from 2 to 20 carbon atoms, one or more of the hydrogen atoms linked to the carbon atoms of R′ and R″ possibly being replaced with halogen atoms, alkyl groups, alkoxy groups, aryl groups, aryloxy groups, amino groups, disubstituted amino groups or silanyl groups; examples of these groups have already been mentioned above for R; and Y represents a group derived from a chain-limiting agent.

50. The composition according to claim 47, in which the catalyst is a hydrosilylation reaction catalyst preferably chosen from platinum-based catalysts, such as H₂PtCl₆, Pt(DVDS), Pt(TVTS), Pt(dba), in which DVDS represents divinyldisiloxane, TVTS represents trivinyltrisiloxane and dba represents dibenzylideneacetone; and transition metal complexes, such as Rh₆(C0)₁₆ or Rh₄(C0)₁₂, C1Rh(PPh)₃, Ir₄(C0)₁₂ and Pd(dba).

51. The composition according to claim 47, further comprising from 1% to 99% by mass of poly(ethynylene phenylene ethynylene silylene) polymer, from 1% to 50% by mass of compound containing only one reactive function and, optionally, from 0 to 1% by mass of catalyst.

52. A modified poly(ethynylene phenylene ethynylene silylene) polymer corresponding to formula (VII) below: 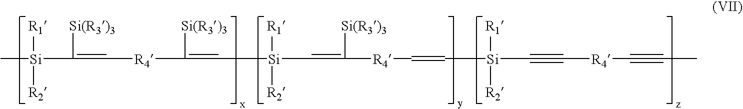
in which R₁′ and R₂′, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, an alkynyl group containing from 2 to 20 carbon atoms, one or more of the hydrogen atoms linked to the carbon atoms of R′₁ and R′₁₂ may be replaced with halogen atoms, alkyl groups, alkoxy groups, aryl groups, aryloxy groups, amino groups, disubstituted amino groups or silanyl groups;
R₃′ represents an alkyl radical of 1 to 20 C such as a methyl radical, an alkenyl radical of 10 to 20 C, or an aryl radical of 6 to 20 C such as a phenyl radical; and
R4′ represents: 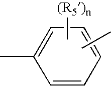
in which the phenylene group may be in the o, m or p form and in which R₅′ represents a halogen atom (such as F, Cl, Br and I), a (linear or branched) alkyl group containing from 1 to 20 carbon atoms, a cycloalkyl group containing from 3 to 20 carbon atoms (such as methyl, ethyl, propyl, butyl, cyclohexyl), an alkoxy group containing from 1 to 20 carbon atoms (such as methoxy, ethoxy, propoxy), an aryl group containing from 6 to 20 carbon atoms (such as a phenyl group), an aryloxy group containing from 6 to 20 carbon atoms (such as a phenoxy group), a (linear or branched) alkenyl group containing from 2 to 20 carbon atoms, a cycloalkenyl group containing from 3 to 20 carbon atoms (such as vinyl, alkyl, cyclohexenyl), an alkynyl group containing from 2 to 20 carbon atoms (such as ethynyl, propargyl), an amino group, an amino group substituted with one or two substituents containing from 2 to 20 carbon atoms (such as dimethylamino, diethylamino, ethylmethylamino, methylphenylamino) or a silanyl group containing from 1 to 10 silicon atoms (such as silyl, disilanyl (—Si₂H₅), dimethylsilyl, trimethylsilyl and tetramethyldisilanyl), one or more hydrogen atoms linked to the carbon atoms of R possibly being replaced with halogen atoms (such as F, Cl, Br and I), alkyl groups, alkoxy groups (such as methoxy, ethoxy and propoxy), aryl groups, aryloxy groups (such as a phenoxy group), amino groups, amino groups substituted with one or two substituents, or silanyl groups; n is an integer from 0 to 4; or R₄′ represents a group containing at least two aromatic nuclei comprising, for example, from 6 to 20 C, linked via at least one covalent bond and/or at least one divalent group; and x and y and z represent, respectively, integers between 0 and 1000.

53. A polymer corresponding to the following formula: 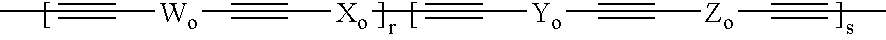
in which:
r and s are integers from 1 to 1000;
Xo∘∘ and Zo, which may be identical or different, each independently represent a group α₁, or a group combination of these groups:
in which α₁ represents: 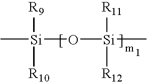
in which α₁ represents: 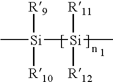
in which:
m₁ and n₁ are integers generally between 1 and 1000 and preferably between 1 and 10;
R₉, R₁₁, R₁₂, R′9, R′₁₀, R′₁₁ and R′₁₂, which may be identical or different, each independently represent a hydrogen atom, an alkyl group containing from 1 to 20 carbon atoms, an alkenyl group containing from 2 to 20 carbon atoms, an alkynyl group containing from 2 to 20 carbon atoms or an aryl group containing from 6 to 20 carbon atoms, the hydrogen atoms linked to the carbon atoms of R₉, R₁₀, R₁₁ and R₁₂ and R′₉, R′₁₀, R′₁₁ and R′₁₂ possibly being partially or totally replaced with halogen atoms, alkoxy groups, phenoxy groups, disubstituted amino groups or silanyl groups;
Wₒ and Yₒ, which may be identical or different, each independently represent a group B₁, a group B₂, a group B₃ or a combination of these groups:
B₁ represents:
—CH₂ [symbol] O [symbol] ᵢR₁₃ [symbol] O [symbol] ᵢCH₂—
in which i is an integer equal to 0 or 1 and the group R₁₃ represents any divalent chemical group comprising one or more aromatic or heterocyclic rings or nuclei; preferably, the group
R₁₃ is chosen from the following groups: 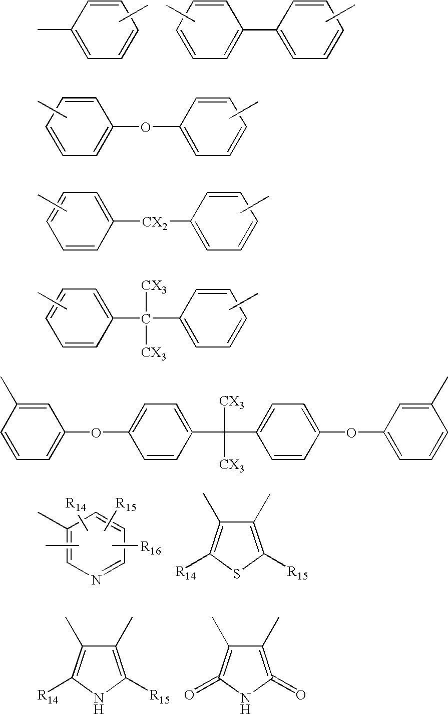
in which X represents a hydrogen atom or a halogen (F Cl, Br or I); and in which R₁₄, R₁₅ and R₁₆, which may be identical or different, have the same meaning as R₉ and each independently represent a hydrogen atom, an alkyl group containing from 1 to 20 carbon atoms, an alkenyl group containing from 2 to 20 carbon atoms, an alkynyl group containing from 2 to 20 carbon atoms or an aryl group containing from 6 to 20 carbon atoms, the hydrogen atoms linked to the carbon atoms of R₁₄, R₁₅ and R₁₆ possibly being partially or totally replaced with halogen atoms, alkoxy groups, phenoxy groups, disubstituted amino groups or silanyl groups;
B₂ represents: 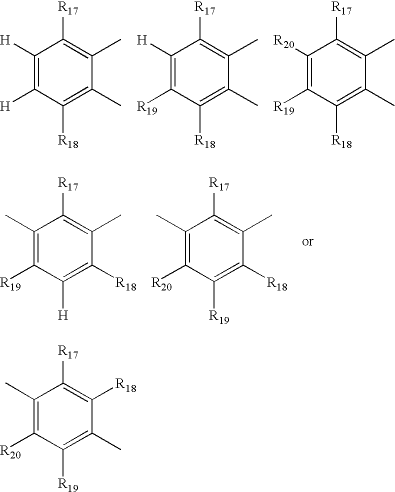
in which R₁₇, R₁₈, R₁₉ and R₂₀, which may be identical or different, each independently represent a halogen atom, an alkyl group containing from 1 to 20 carbon atoms, an alkoxy group containing from 1 to 20 carbon atoms, a phenoxy group containing from 6 to 20 carbon atoms, an aryl group containing from 6 to 20 carbon atoms, a substituted amino group containing from 2 to 20 carbon atoms or a silanyl group containing from 1 to 10 carbon atoms, the hydrogen atoms linked to the carbon atoms of the substituents R₁₇, R₁₈, R₁₉ and R₂₀ possibly being totally or partially replaced with halogen atoms, alkoxy groups, phenoxy groups, disubstituted amino groups or silanyl groups;
B₃ represents:
a group chosen from divalent heterocycles such as those defined in the context of the definition of the group R₁₃ of B₁.

54. The polymer according to claim 53, wherein the repeating unit corresponds to formula:

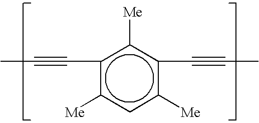

55. The polymer according to claim 53, wherein the repeating unit corresponds to formula:

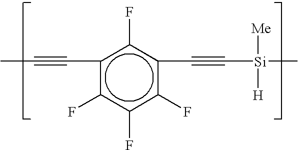

56. A cured product that may be obtained (that is obtainable) by heat treatment at a temperature of from 50 to 500° C. of a modified poly(ethynylene phenylene ethynylene silylene) polymer obtainable by selective addition of a compound containing only one reactive function on the acetylenic bonds of a poly(ethynylene phenylene ethynylene silylene) polymer, optionally in the presence of a catalyst.

57. A composite matrix comprising a modified poly(ethynylene phenylene ethynylene silylene) polymer obtainable by selective addition of a compound containing only one reactive function on the acetylenic bonds of a poly(ethynylene phenylene ethynylene silylene) polymer.

58. The modified polymer according to claim 1, in which the compound represents from 1% to 50%.

59. The modified polymer according to claim 1, in which the compound represents from 10% to 40%.

60. The modified polymer according to claim 16, in which the number-average molecular mass of polymers (I), (Ia) and (Ib) is from 400 to 5000, and the weight-average molecular mass is from 600 to 10000.
